(19) United States
(12) Patent Application Publication
(10) Pub. No.: US 2024/0403810 A1
(43) Pub. Date: Dec. 5, 2024

(54) METHOD AND FACILITY FOR PRODUCING DRIED-RECOVERED HOUSEHOLD FOOD

(71) Applicant: Chewie Labs LLC, San Bruno, CA (US)

(72) Inventors: Geoff Hill, Seattle, WA (US); Rohan Raman, San Francisco, CA (US); Matthew Rogers, San Francisco, CA (US); Harry Tannenbaum, San Francisco, CA (US); Ross Mazur, San Francisco, CA (US); Azita Sayadi, San Francisco, CA (US); Alyssa Pollack, Lone Tree, CO (US)

(21) Appl. No.: 18/731,822

(22) Filed: Jun. 3, 2024

Related U.S. Application Data
(60) Provisional application No. 63/506,160, filed on Jun. 5, 2023.

(51) Int. Cl. G06Q 10/0833; G06Q 10/087

(52) U.S. Cl. CPC G06Q 10/0833; G06Q 10/087

(57) ABSTRACT

Embodiments disclosed herein provide various systems and methods for producing dried-recovered household food (DRHF) from organic matter that has been preprocessed by an organic matter processing apparatus (OMPA). The OMPA can convert organic inputs into a ground and selectively dried product, referred to herein as OMPA output. A DRHF processing facility can convert OMPA output, received from many different households, into DRHF. The DRHF facility conducts extensive data acquisition and analysis of OMPA output and DRHF at many different stations existing within the DRHF processing facility. A chain of custody, starting with receipt of OMPA output from households throughout a conversion process in which the OMPA output is converted to DRHF is maintained to ensure that the production of DRHF and the DRHF itself satisfies requirements for food safety and handling, thereby allowing the DRHF to be used as feed or as a feed ingredient.

### CROSS-REFERENCE TO A RELATED APPLICATION

This patent application claims the benefit of U.S. Provisional Patent Application No. 63/506,160, filed Jun. 5, 2023, the disclosure of which is incorporated herein in its entirety.

### TECHNICAL FIELD

This patent specification relates to systems and methods for producing dried-recovered household food from organic matter that has been preprocessed by organic matter processing apparatuses, and more particularly to obtaining data related to source material for producing the dried-recovered household food.

### BACKGROUND

The terms “waste management” and “matter disposal” may be used to refer to the activities required to manage generation, transport, treatment, and disposal of waste loads or matter, together with monitoring the process to ensure compliance with related ordinances, rules, and laws. Waste loads can include any combination of matter such as food matter, mixed organics, yard waste, recyclables, and inorganics. Landfills represent the oldest form of waste management.

When food matter is deposited in landfills, the food matter degrades under anerobic conditions into methane-a powerful greenhouse gas. These harmful emissions can be avoided by diverting food matter from landfills. Some countries have even made legislative efforts to reduce the amount of food matter that ends up in landfills. South Korea, for example, passed a law in 2013 that not only required food matter be discarded in biodegradable bags, but also imposed a fee based on the weight of food matter to be discarded.

Households and other residential domiciles have occupants who may engage in “at home” compositing or preprocessing of organic matter. Such occupants may place their organic matter in a composting bucket or a device that dries and grinds the organic matter. What is needed is an organization or a membership that collects dried and ground organic matter and processes it so it can be used for another purpose.

### BRIEF SUMMARY

Embodiments disclosed herein provide various systems and methods for producing dried-recovered household food (hereinafter DRHF) from organic matter that has been preprocessed by an organic matter processing apparatus (hereinafter “OMPA”). The OMPA can convert organic inputs into a ground and selectively desiccated product, referred to herein as OMPA output. A DRHF processing facility can convert OMPA output, received from many different households, into DRHF. The DRHF facility conducts extensive data acquisition and analysis of OMPA output and DRHF at many different stations existing within the DRHF processing facility. A chain of custody, starting with receipt of OMPA output from households throughout a conversion process in which the OMPA output is converted to DRHF is maintained to ensure that the production of DRHF and the DRHF itself satisfies requirements for food safety and handling, thereby allowing the DRHF to be used as a feed or as a feed ingredient (e.g., for animals, fish, or insects).

A further understanding of the nature and advantages of the embodiments discussed herein may be realized by reference to the remaining portions of the specification and the drawings.

### BRIEF DESCRIPTION OF THE DRAWINGS

FIG. 1A shows a graphical illustration of a matter generation and remediation cycle according to an embodiment.

FIG. 1B shows illustrative matter management flow paths according to an embodiment.

FIG. 2 shows an illustrative block diagram according to an embodiment.

FIG. 3 shows an illustrative block diagram of DRHF processing facility according to an embodiment.

FIG. 4 shows an illustrative perspective view of a feed ingredient production facility according to an embodiment.

FIGS. 5A and 5B show illustrative schematic diagrams of feed ingredient production facility according to an embodiment.

FIG. 6 shows an illustrative block diagram of data being collected by a DRHF facility according to an embodiment.

FIG. 7 shows an illustrative block diagram of customer-tied data being collected by a DRHF facility according to an embodiment.

FIG. 8 shows an illustrative block diagram of batch-tied data being collected by a DRHF facility according to an embodiment.

FIG. 9 shows an illustrative block diagram of a system using multiple processing lines to convert OMPA output to DRHF according to an embodiment.

FIGS. 10-15 show different processes according to different embodiments.

FIG. 16 shows illustrative block diagram of software platform according to an embodiment.

FIG. 17 shows an illustrative screen shot of a front end application being implemented on a device according to an embodiment.

FIG. 18 includes a high-level illustration of an OMPA in accordance with various embodiments.

FIG. 19 illustrates a network environment that includes a control platform.

FIG. 20 is a block diagram illustrating an example of a computing system in which at least some operations described herein can be implemented.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

As defined herein, an organic matter processing apparatus (OMPA) is an aero-mechanical device operative to convert OMPA input into an OMPA output using judicious combinations of physical, aero, and thermal processes including grinding, paddling, electric heating, and airflow.

OMPA input is defined herein as predominantly organic matter that is intended for processing by the OMPA. OMPA input can include food matter and/or mixed organic matter. Food matter can include consumable food items such as fats, oils, sweets such as sugars and chocolates, dairy products such as milk, yogurt, cheese, proteins such as meat (and bones thereof), poultry (and bones thereof), fish (and bones thereof), beans, eggs, and nuts, vegetables, fruits, and starches such as bread, cereal, pasta, and rice. Food matter is sometimes referred to as foodstuffs. Mixed organic matter can include paper or other fiber materials (e.g., soiled napkins or paper towels), compostable resins, compostable plastics, cellulosic materials (e.g., compostable silverware), and other non-food organic materials. OMPA input can also include other types of biodegradable matter (e.g., compostable diapers).

For many implementations, OMPA input may include food matter and/or mixed organic matter that is post-consumer, post-commercial, or post-industrial in nature, matter that if not processed according to the present teachings could be considered as waste, garbage, refuse, leavings, remains, or scraps. By way of example, food that is leftover on a child's dinner plate, and not in suitable condition or quantity to be stored and served later as leftovers, can represent one example of OMPA input. As another example, items such as potato peels, apple cores, cantaloupe rinds, broccoli stumps, and so forth, and similar organic materials that are spun off from the food preparation process, can represent other examples of OMPA input.

OMPA output is defined herein as processed organics derived from transformation of organic matter processed by the OMPA to yield a ground and selectively dried product. The processed organics can be a substantially desiccated product having water content ranging between 0.1 and 30 percent of total weight, between 5 and 25 percent of total weight, between 5 and 20 percent of total weight, between 1 and 15 percent of total weight, between 5 and 15 percent of total weight, between 10 and 15 percent of total weight, between 10 and 20 percent of total weight, between 15-20 percent of total weight, or between 10 and 25 percent of total weight. Alternatively, the processed organics can be a substantially dried product having water content of less than 15 percent of total weight, less than 10 percent of total weight, or less than 5 percent of total weight. The processed organics can exist as granulated or ground media. One type of processed organics can be FOOD GROUNDS™.

As defined herein FOOD GROUNDS™ refers to an OMPA output characterized as having a minimum nutritional value. FOOD GROUNDS™ can be derived from OMPA input comprised of a minimum percentage of food matter such that the FOOD GROUNDS™ OMPA output has the minimum nutritional value. The minimum percentage of food matter can ensure that the FOOD GROUNDS™ OMPA output attains at least the minimum nutritional value. For example, a higher nutrient value OMPA output can be more readily obtained from food matter than from mixed organics such as fiber materials and cellulosic materials.

As defined herein, an OMPA output processor repurposes the OMPA output for a commercial purpose. For example, the OMPA output can be used as feed or feedstock for feed for animals, fish, or insects. In some embodiments, an OMPA output processor that receives FOOD GROUNDS™ may produce a derivative product having a higher intrinsic value (e.g., nutritional, monetary, or both nutritional and monetary) than a derivative product produced primarily from mixed organics such as fiber materials and cellulosic materials.

As defined herein, inorganic matter and undesirable matter refer to matter that can be added to an OMPA or provided to an OMPA output processor but is incapable of being rendered into an DRHF suitable for use as feed or a feed ingredient. Inorganic matter can include, for example, metals, plastics, glass, ceramics, rocks, minerals, or any other substance that is not linked to the chemistry of life. Undesirable matter can refer to the garbage or waste that a resident or business disposes in a conventional trash bin for transport to a landfill processor, recyclables typically transported to recyclables processor, or a yard waste that is transported to a yard waste processor. If any of such inorganic or undesirable matter is provided to an OMPA output processor (e.g., that is specifically designated for producing feed or feed ingredients), the OMPA output processor can filter out the inorganic and undesirable matter.

In one embodiment, the OMPA is designed to be used primarily in a residential context (e.g., in single family homes, townhouses, condos, apartment buildings, etc.) to convert residential based OMPA input into residential sourced OMPA output. Converting residential generated OMPA input to OMPA output can have a net positive effect in the reduction of methane and space occupied by landfills or compost centers by redirecting the OMPA input and the OMPA output thereof away from traditional reception centers of such material. Moreover, because the OMPA is user friendly, aesthetically pleasing, energy efficient, clean, and substantially odor free, the OMPA provides an easy to use platform for the residential sector to handle OMPA input (e.g., food scraps, etc.), thereby making the decision on what to do with residential based OMPA input an easier one to handle. The OMPA can convert OMPA input into FOOD GROUNDS overnight, where the FOOD GROUNDS are substantially odorless, easily transportable, and shelf-stable. The FOOD GROUNDS can remain in the OMPA until it is full, at which point the FOOD GROUNDS are removed and transported to an OMPA processing facility, which may convert the FOOD GROUNDS into a higher value food product (e.g., animal feed). It should be understood that OMPAs can be used to serve entire communities, cities, and industries. Use of OMPAs in these other sectors, as well as the residential sector, can result in diversion from landfills and further serve a goal of preventing OMPA input from becoming waste in the first place by converting it into usable products that can be used to enable more resilient, sustainable food systems.

As defined herein, dried recovered household food (DRHF) refers to OMPA output that has been processed in a DRHF processing facility to ensure that the DRHF adheres to a set of criteria suitable for use as feed or feedstock for feed. DRHF is food, a dried recovered food obtained through processing of OMPA output according to embodiments discussed herein. DRHF meets criteria for chemical composition, digestibility of energy and amino acids, and safety (e.g., foodborne pathogens, mycotoxins, and heavy metals are either absent or below government regulatory threshold levels). In some embodiments, DRHF is used as a feed ingredient in poultry feed, particularly for broiler poultry and layer poultry. Poultry feed rations can include DRHF and other conventional feed ingredients such as corn, soybean meal, dicalcium phosphate, limestone, synthetic amino acids, salt, vitamin premix, and mineral premix. In some embodiments, it has been found that feed formulations having DRHF incorporation rates of up to 33% and 37% (by weight) were sufficient to avoid any nutrient deficiencies or electrolyte imbalances in broiler and layer rations, respectively. In the broiler ration, DRHF displaced corn, soybean meal, and limestone to varying degrees, while corn, soybean meal, animal fat, dicalcium phosphate, and limestone were substantially displaced in the layer rations. The addition of vitamin premix may be required to facilitate DRHF inclusion in the layer rations. In other embodiments, DRHF can be used as feed or feedstock for feed for other animals, fish, or insects.

As defined herein, a DRHF processing facility subjects the OMPA output to a series of process steps that transforms or conditions the OMPA output into DRHF. The DRHF processing facility may be an example of an OMPA output processor. The processing steps can include inspection to determine whether the OMPA output should be discarded or accepted for further processing, metal extraction to remove any metal contaminants, screening for one or more different sizes, pasteurization to kill pathogens, mixing, milling, quality assessment, data acquisition, and output (e.g., bagging). A DRHF processing facility may have multiple processing lines for conditioning OMPA output of varying quality and characteristics. For example, in one embodiment, OMPA output that exceeds sizing criteria may be routed through a dedicated processing line suitable for relatively larger OMPA output particulates and OMPA output that falls below sizing criteria may be routed to a processing line suitable for relatively smaller OMPA output particles. As another example, in another embodiment, OMPA output having a known quality profile (e.g., OMPA output derived primarily from vegetarian food sources or having an infrared spectroscopy profile that meets a predefined quality profile) may be routed to an appropriate processing line within the processing facility. As a specific example, the DRHF processing facility may be tasked with producing DRHF having a fixed range of nutritional characteristics (e.g., fixed percentages of crude protein, crude fat, and neutral detergent fiber, and a minimum kcal/g of nitrogen-adjusted true metabolizable energy), which characteristics may be requested by a farmer or DRHF utilization partner (defined below) as desired DRHF parameters. With knowledge of the OMPA output quality profile, the DRHF processing facility can selectively mix and/or route different OMPA output batches to produce DRHF that has the desired nutritional characteristics.

As defined herein, dried recovered household organic matter (DRHOM) refers to OMPA output that has been processed in a processing facility to produce a dried recovered organic matter product. DRHF, for example, is a specific type of DRHOM that is produced in a DRHF facility. Another example of DRHOM can include briquettes or pellets that are used as fuel for a fire. The briquettes or pellets are not intended for use as food but can be used for non-food purposes. DRHOM processing facilities can be used to convert OMPA output to a recovered organic matter product (e.g., a product that has a non-food use). It should be understood that while the focus of many embodiments discussed herein involve production of DRHF, the data acquisition thereof, and the analysis and reporting of the data, many of the concepts that apply to DRHF also apply to DRHOM.

As defined herein, a mailer refers to a package that has been received by a DRHF processing facility and that has a tracking number label attached thereto and OMPA output contained therein. The tracking number label may be associated with a customer account. That customer account may be maintained in a database that keeps track of all information related to OMPA output produced by that customer's OMPA and the data related to the OMPA output received in prior mailers by that customer. The tracking number label may also be used by a front end device operating in the DRHF facility as a basis for a mailer-entry or customer-tied entry for populating a data set related to a particular mailer. That data set can be uploaded and stored in the database. The mailer may be a cardboard box with a plastic bag that contains the OMPA output. The mailer may be delivered to the DRHF facility by a privately held or government based delivery service.

As defined herein, a DRHF utilization partner refers to an entity (e.g., a company) or person (e.g., farmer) that uses DRHF as feed or an ingredient for feed for animals, fish, insects, or another organism that can consume DRHF.

As defined herein, an organic matter data set (OMDS) can include data related to a particular OMPA and any batch of OMPA output provided by that OMPA. The OMDS can include mass, volume, and moisture data for a batch of OMPA output that is removed from the OMPA and transported to a DRHF processing facility. The OMDS can include a time stamp (e.g. of when the OMPA bucket is emptied of its OMPA output), location data (e.g., GPS, IP address, user entered address, etc.), account information (e.g., customer account number), sensor data (e.g., infrared sensor data, image data), user interaction events and a log of operational parameters exercised by the OMPA during production of the OMPA output. The log of operation parameters may keep track of each OMPA processing cycle, including details (e.g., time duration and bucket temperature) of the operational states within each OMPA processing cycle (e.g., whether a high intensity processing state was completed in its entirety or whether such a state was interrupted by a user).

As defined herein a customer-tied data set may refer to data entered into a front end device that relates to the mailer and the OMPA output contained in the mailer. The data may be obtained from an operator who manually inputs data or selects UI elements on the front end device, from peripheral devices or sensors that obtain data, or a combination of both.

As defined herein, batch data or batch-tied data may refer to data obtained from a batch of OMPA output collected from several mailers that is processed through the DRHF facility to become DRHF. Batch data may be stored in a database that keeps track of all the data related to each batch of DRHF produced by the DRHF facility. The batch data may be collected by a front end device and uploaded to a backend server for storage in the database. The batch data may be obtained from peripheral devices or sensors, user input, or both.

As defined herein, DRHF data refers to data obtained during processing of OMPA output in the DRHF processing facility. DRHF data can include data related to the DRHF being provided by the DRHF processing facility. For example, such data can include mass, moisture content, screened size, nutritional content, or any combination thereof. DRHF data can also include operational parameters of the DRHF processing facility such as sensor data (e.g., IR sensor data, image data), blower speeds, belt and auger speeds, pasteurization temperature, mass values, etc.

As defined herein, OMPA feedback data can refer to adjustments to OMPA operation for a specific OMPA (e.g., run a high temperature processing cycle for 30 extra minutes), notices to a user of a specific OMPA (e.g., inform the user that OMPA output provided to the DRHF facility was discarded because it was too wet and moldy or because it contained too many prohibited items), or a combination thereof.

It should be understood that although dried recovered household food refers to feed or feed ingredients derived from OMPA output sourced primarily from residential domiciles (e.g., single family homes, townhouses, condos, apartment buildings, etc.), DRHF may be derived from OMPA output sourced from non-residential sources such as industrial and commercial locations. In some embodiments, DRHF may be produced from any variety of OMPA output sourced from any location that has a membership or access to DRHF facilities.

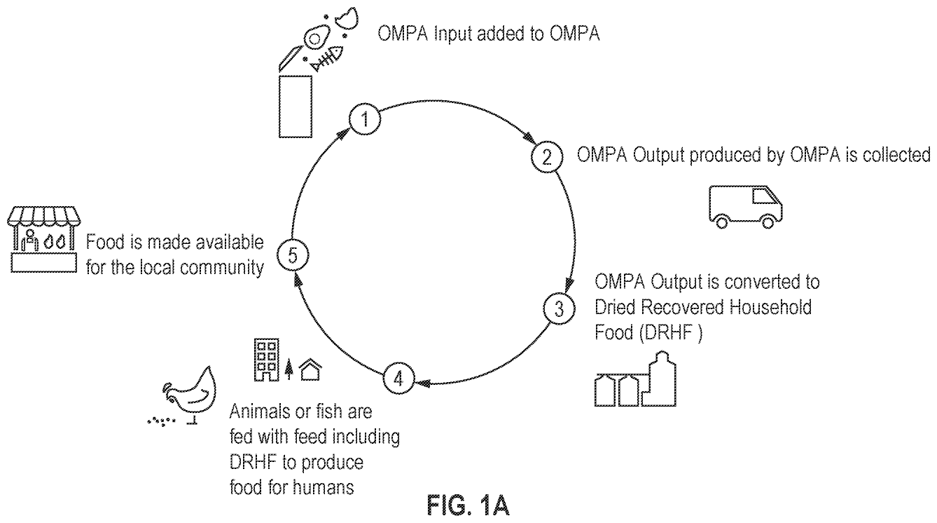

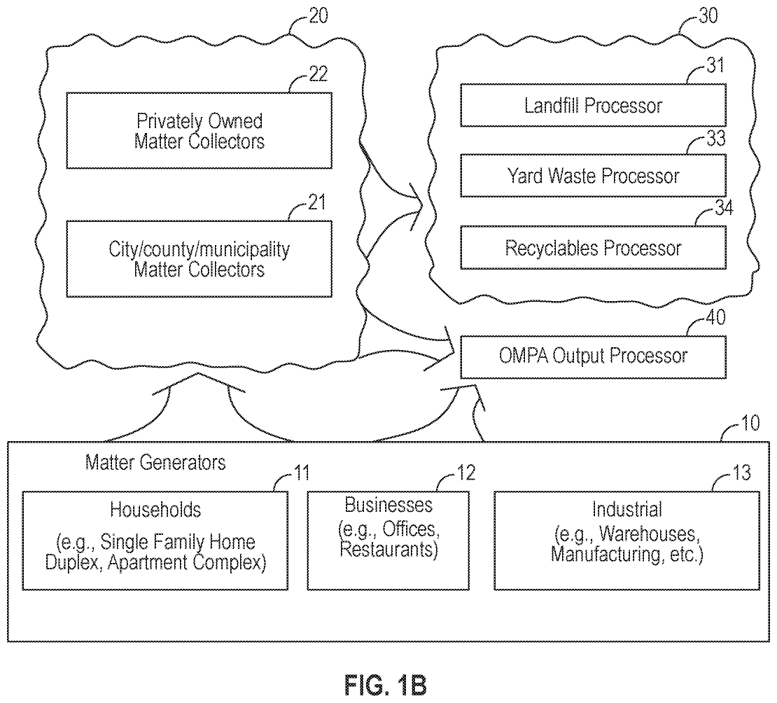

FIG. 1A shows a graphical illustration of an organic matter remediation cycle according to an embodiment. As shown in step 1, OMPA input is added to an OMPA, which converts the OMPA input to OMPA output. At step 2, the OMPA output is collected and delivered to an OMPA output processor (e.g., a DRHF facility), effectively preventing the OMPA input from ending up in a traditional landfill and thereby reducing or eliminating generation of methane that would be generated if the OMPA input was placed in the landfill. At step 3, the OMPA output is converted to DRHF. The DRHF is used as feed or as a feed ingredient to feed animals (e.g., chickens) or fish to produce food for humans, at step 4. The food (e.g., animal or fish that consumed the DRHF) is provided for consumption by humans at step 5. The cycle repeats by reverting back to step 1. Embodiments discussed herein focus on steps 2 and 3—the receipt of OMPA output and production of DRHF and all data related to the received OMPA output, the DRHF, and the processing of that data.

FIG. 1B shows illustrative matter management flow paths according to an embodiment. One path includes matter generators 10, matter collectors 20, and matter processors 30. Another path eliminates matter collectors 20 and includes only matter generators 10 and matter processors 30. Matter generators 10 can include any conceivable generator of matter, which can include non-processed matter, processed organics (i.e., OMPA output), or a combination of non-processed matter and processed organics. As shown, matter generators can be generically classified as household generators 11, business generators 12, and industrial generators 13. Household generators 11 can include, for example, single family homes, duplexes, apartment complexes, condos, co-ops, or any other type of residence. Business generators 12 can include, for example, office buildings, restaurants, shopping centers, sports arenas, theme parks, or any other non-industrial type of business or commercial enterprise. Industrial generators 13 can include, for example, warehouses, manufacturing facilities, food processing facilities, or any other relatively large-scale facility.

Matter collectors 20 can include any conceivable collector of matter. City/country/municipality matter collectors 21 may represent government run or appointed matter collectors that are responsible for collecting matter from generators 10. Privately owned matter collectors may represent private entities that collect matter from generators 10.

Matter retention sites 30 can include multiple different processors dedicated to handling specific types of matter. For example, landfill processor 31 can represent a generic “catch-all” processor for handling all matter. However, it is desirable to filter or sort matter to other processors that can more efficiently handle that particular matter. Yard waste processor 33 may handle yard waste. Recyclable processor 34 may handle recyclable materials. Any matter that cannot be handled by one of processors 32-34 may be handled by landfill processor 31.

OMPA output processor 40 may handle OMPA output that has been collected by a matter collector or mailed thereto. In some embodiments, OMPA output processor 40 may be a DRHF processing facility. OMPA output processor 40 is shown to exist separately from matter retention site to illustrate that OMPA processor 40 does not exist within conventional trash, recyclables, and yard waste treatment flows. When processor 40 is a DRHF processing facility, processor 40 can produce DRHF for use as feed or feed ingredient. Separating food matter from other matter such as inorganic matter can be a significant hassle. As a result, roughly 95 percent of food matter is disposed in landfills. Food matter will degrade into methane as it rots in a landfill, however. As such, it would be beneficial to process food matter before it reaches the landfill, for example, into a shelf stable product that can be diverted from the landfill and used for another purpose.

Introduced herein are systems and methods that alter the conventional flow of generated matter by providing a resource preservation system that recovers organic matter in the form of OMPA output from any OMPA and converts the OMPA output to DRHF for use as feed or as a feed ingredient. OMPAs can process OMPA input in an automated and intelligent manner to create OMPA output. The OMPA can neutralize food matter and mixed organics by drying and processing (e.g., grinding) it into a ground and selectively desiccated product that is suitable for further processing at a DRHF facility according to embodiments discussed herein.

In contrast to compost that is commonly prepared by decomposing food matter, the OMPA output produced by the OMPA may still have food value (also referred to as “nutritional value”). At a high level, the OMPA output is comprised of small fragments of dried processed organics that have a roughly similar consistency throughout. Accordingly, the OMPA output could be used in various ways. For example, the OMPA output could be given to domestic animals (e.g., livestock) as animal feed. As another example, the OMPA output could be deposited into a garden for decomposition into compost. The OMPA output could also be introduced into conventional composting workflows, for example, through deposition into a compost bin that is emptied on a periodic basis.

As further discussed below, one notable benefit of the OMPA output is its weight and form. To participate in a conventional composting workflow, individuals have historically had to deposit food matter into dedicated containers (referred to as “compost bins”). The food matter that is deposited into these compost bins will occupy significant amounts of space, however. Moreover, the food matter in these compost bins may quickly decompose into a much wetter form. Together, these problems can make participation in the conventional composting workflow a burden. By processing food matter and mixed organics into OMPA output, an OMPA can produce a pre-cursor product that is not only easier to handle (e.g., transport, store, or use), but is also more shelf stable over long intervals of time due to the relative absence of water.

The OMPA output can be produced by any OMPA such as that described, for example, in commonly owned U.S. Patent Publication Nos. 20230070014, 20230083105, 20230084646, 20230081670, 20230081656, and 20230083366, the disclosures of which are incorporated herein by reference in their entireties. Other OMPA devices may be used to produce OMPA output. However, any OMPA output from an OMPA that is not part of a membership that includes access to a DRHF facility may be subject to extra scrutiny if received by a DRHF facility or the user of the non-member OMPA may have to sign up to a membership before they are able to transmit their OMPA output to a DRHF facility.

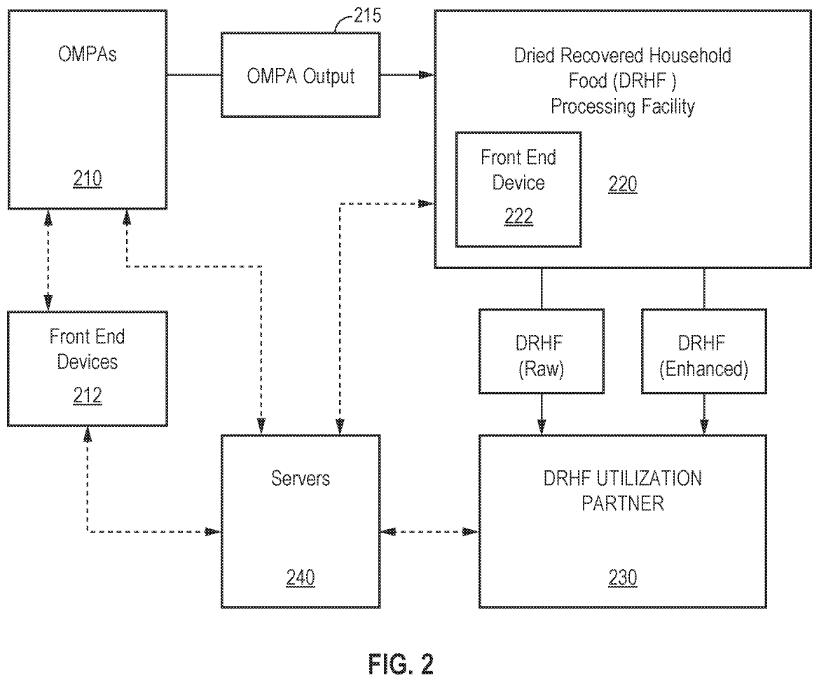

FIG. 2 shows an illustrative block diagram showing the flow of product, data, or product and data among OMPAs 210, front end devices 212, a DRHF processing facility 220, front end device 222, a DRHF utilization partner 230, and one or more servers 240. OMPAs 210 may provide OMPA output 215 to DRHF processing facility 220. OMPAs 210 may also provide data to and receive data from one or more servers 240. For example, OMPAs 210 may provide OMDSs to one or more servers 240, and one or more servers 240 may forward all or a portion of the OMDS to processing facility 220. As another example, one or more servers 240 may provide data to one or more OMPAs 210. Such data may include, for example, system updates, changes to an OMPA processing cycle, or user defined setpoints such as preferred runtimes. Data changing the OMPA processing cycle may be derived from a central system responsible for managing and monitoring operation of OMPAs or such data may be derived from analysis of OMPA output received by processing facility 220. Front end devices 212 (e.g., mobile device, laptop, tablet, or other computer device) may communicate with OMPAs 210 and one or more servers 240 to exchange data and executable commands. Front end device 212 may run an application or access a website that enables a user to manage his or her OMPA, receive notifications related to use of the OMPA, access information related to use of the OMPA, or request additional shipping boxes with pre-addressed, pre-paid labels. Front end device 222 may be able to receive operator inputs and data from various peripheral devices located at various stations within processing facility 220. In addition, front end device 222 may communicate data with servers 240.

DRHF processing facility 220 can condition OMPA output to yield DRHF according to embodiments discussed herein. The DRHF output can be raw or enhanced. Raw DRHF represents a pure DRHF product in which no additional ingredients have been added. Raw DRHF may be used as feed or as an ingredient in feed. Enhanced DRHF represents a supplemented product in which one or more ingredients (e.g., feed ingredients such as corn, soybean meal, salts, vitamins, etc.) have been mixed in with the DRHF. In some embodiments, enhanced DRHF can be a finished feed specifically formulated for a particular fish or animal.

DRHF data obtained by DRHF processing facility 220 may be provided to one or more servers 240. The DRHF data may include details of the DRHF produced from a given batch of OMPA output. In some embodiments, the DRHF data may specify where a batch of DRHF is being used so that this information can be fed back to a user's front end device 212 via one or more servers 240. OMPA feedback data is obtained by processing facility 220 in connection with an OMPA output batch associated with a particular OMPA user can be transmitted to the OMPA and/or front-end device associated with that particular OMPA user. For example, OMPA feedback data may adjust a sanitization runtime for the OMPA because the OMPA output received from the OMPA had a higher than desired moisture content. As another example, the OMPA feedback data may cause a reminder notice to be displayed on the front-end device to remove stickers from OMPA input before being inserted into the OMPA.

DRHF data may be used by one or more front-end devices 222 associated with processing facility 220. Such front-end devices may be responsible for controlling operation of processing facility (e.g., controlling sensors such as cameras, mass sensors, olfactory sensors, infrared sensors, etc. and controlling mechanical systems such as belts, augers, fans, etc.), for responding to human controls or automated controls, and accessing database information (e.g., for pulling OMPA account information for each OMPA output package being processed).

The raw DRHF may be sent to a DRHF utilization partner 230 who may then use it as feed or as an ingredient for producing a feed. The enhanced DRHF may be sent to another DRHF utilization partner 230 who may then use it as feed. DRHF data (e.g., mass, moisture content, composition, timestamp, etc.) may accompany the raw or enhanced DRHF being provided to utilization partner 230 via one or more servers 240.

Utilization partner 230 may place orders with processing facility 220 by submitting orders via one or more servers 240. These orders can specify desired DRHF parameters and can vary significantly from one order to the next. For example, one order may request x amount of raw DRHF, where x is a mass value. As another example, the order may request x amount of raw DRHF having predefined nutritional values. Yet another example, the order may request x amount of a specific feed (i.e., enhanced DRHF) such as a broiler chicken feed or a layer chicken feed.

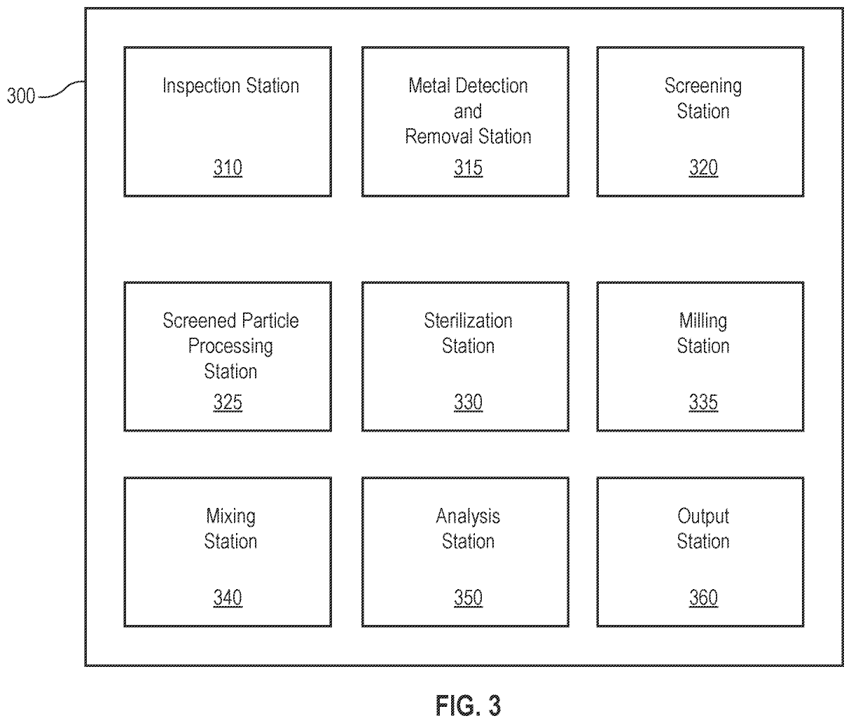

FIG. 3 shows an illustrative block diagram of DRHF processing facility 300 according to an embodiment. Processing facility 300 can include inspection station 310, metal detection and removal station 315, screening station 320, screen particle processing station 325, sterilization station 330, milling station 335, mixing station 340, analysis station 350, and output station 360. Processing facility 300 can utilize any one or more of the stations in any order. Inspection station 310 may represent the first step in a transformation process of converting OMPA output to DRHF. The OMPA output can be received in mailed boxes-mailers-that are collected for batch processing through facility 300. Each mailed box has identifying information (e.g., a tracking label number) that can be scanned so that a front-end device can correlate the identifying information to a customer account and setup a customer-tied data entry point within the front end device. Moreover, with knowledge of the customer account, the front end can access customer account history (e.g., a history of prior mailers transmitted by this customer) and the OMDS associated with that particular mailer (e.g., the data and operating parameter used by the OMPA to generate the OMPA output provided in the mailer). An operator, either a human, machine, robot, or combination thereof, can perform outside of the box inspections. Such inspections can include weighing the box, visually inspecting the box (e.g., for clear signs of damage that may indicate that the OMPA output is compromised in some way that would alert the operator that such box should be discarded or placed in an alternative processing line dedicated for handling non-conforming OMPA output), inserting a probe into the box that is capable of taking measurements (e.g., such as humidity, gas profile, and factors pertaining to potential presence of mold or other potentially hazardous material), x-raying the box to determine whether any quality or hazardous materials are present in the box. If any of the outside of the box inspections fail, that box is either discarded or sent to an alternative processing line dedicated for handling non-conforming OMPA output. Any of this data can be added to a customer-tied entry in the front end device and stored as a data set.

After the outside the box inspections are completed, in-box inspections may occur. In-box inspections occur by opening the box and inspecting the OMPA output contained therein. In-box inspections can include visual inspections, olfactory inspections, and content analysis. These inspections can be performed using human senses (e.g., sight, smell, and touch), with sensors that are able to replicate human senses, and sensors that can obtain additional insights beyond the capabilities of humans (e.g., infrared, image capture analysis, spectrographic analysis, etc.). A photograph of the OMPA output can be taken, stored, analyzed, and attributed to a customer-tied account. Sensors can be used to assess additional qualities of the OMPA output, including, for example, presence of drugs, nutritional content (e.g., protein, fat, and fiber content), and whether any contaminants are present. At any point during the in-box inspection process, the OMPA output can be accepted, rejected, or sent to an alternative line. Any of this data can be added to a customer-tied entry in the front end device and stored as a data set.

As part of the inspection process, the OMDS is accessed for each box. The OMDS can include metrics of the OMPA output and customer account information. The inspection station can compare metrics of the OMPA output with measurements and sensor readings obtained during out of box and in-box inspections to determine whether to accept that OMPA output of that box for further processing through a primary line, reject the box, or route the OMPA output to an alternative line. For example, if OMDS indicates that the weight of the OMPA output was x pounds, but the weight of the OMPA output determined by inspection station 310 was outside of an acceptable deviation range of that x pounds (e.g., not within 10% of the OMDS weight), that box of OMPA output may be flagged for additional scanning or rejected.

The customer account information can be associated with inspection results of previously submitted OMPA outputs. For example, if a customer has a known history of problematic OMPA output (e.g., history of including stickers, plastics, or other forbidden items), inspection station 310 may subject that box to extra scrutiny during the inspection process. As another example, if a customer has a known history of supplying OMPA output having a consistent nutritional value (e.g., because the user primarily has a vegetarian diet, a meat diet, or a balanced diet) or the user has provided advance indication of the primary food sources used in his or her or family's diet, the inspection station may be able to verify whether the current box corresponds with the user's history or the user's advance indication of food sources and use that box accordingly in process facility 300. Prior knowledge or anticipated OMPA output characteristics for a given mailer can enable operators of process facility 300 to selectively create custom blended batches of DRHF. Such blending may be created by presorting mailers according to account users and processing those boxes through process facility 310 as a batch designated for a particular blend.

The process for creating specific blends of DRHF can be expanded on in many different ways. For example, multiple processing lines may exist within processing facility 300. During inspection, the OMPA output for a given box can be routed through the appropriate processing line so that the end product achieves the desired result. For example, assume that two different DRHF blends are needed. Inspection station 310 can selectively route contents of different mailers to the appropriate processing line based on monitored characteristics of the OMPA output in each mailer or prior known factors associated with the customer associated with the mailer so that the different DRHF blends can be achieved. In some embodiments, the end product produced by each processing line can be selectively blended to achieve desired DRHF characteristics.

In some embodiments, each box of OMPA output can be tagged with a non-ferrous trackable object that can flow through a processing line to the end product. When the end product is ready to be shipped to a DRHF utilization partner, the trackable object can be scanned and a process can be initiated to inform the customer associated with the OMPA output where his or her OMPA output is being sent.

In some embodiments, data acquired after inspection of each box, including outside and inside the box, may be committed to a process flow that provides a report card to the customer specifying various information related to the inspection. For example, the report card can include a photo, yield (e.g., mass in kilograms or pounds), and quality (e.g., low, medium, or high quality) of the OMPA output received by the DRHF facility. The report can include specific notes further characterizing the OMPA output (e.g., presence of stickers was found in the last batch of OMPA output). In addition, the report card can be presented as an email to the user, a notification on the user's phone or other personal device, or in an application running on a device. Furthermore, in some instances, the process flow can include specific instructions (e.g., run heater at a higher temperature and for a longer duration to ensure the organic matter is sufficiently dried) to modify the operation of the OMPA that produced the OMPA output under inspection.

Metal detection and removal station 315 is operative to detect presence of metal in OMPA output from a particular box. If metal is detected in the OMPA output, the entire contents of the box may be diverted from a primary processing line for further processing. For example, in one embodiment, if station 315 detects metal in a box of OMPA output, the OMPA output may be diverted to a collection container, where the contents thereof can be sorted to remove ferrous and non-ferrous metals. In one embodiment, when the metal contents are removed, the remainder of the OMPA output may be placed back into the primary processing line or an alternative processing line. In another embodiment, the entirety of the metal contaminated OMPA output can be sent to a black soldier fly (BSF) processing line so that valuable and non-contaminated BSF larva feed can be obtained from metal rejected OMPA output.

If OMPA output is determined to contain metal, station 315 may update the customer account associated with that box of OMPA output with an indication that this customer has placed metal into his or her OMPA. This may result in applying extra scrutiny to future received boxes from this account holder.

Many different techniques may be used for detecting presence of metal in OMPA output. Some techniques may solely detect the presence of metal, while other techniques may detect and remove metal. Magnet based techniques may be used to detect ferrous metals and eddy current techniques may be used to detect non-ferrous metals.

Screening station 320 can sift the OMPA output according to various sizes as desired. In one embodiment, a single screen can be used to yield particles that are classified as either unders (which are desirable particles having a fixed size or less) or overs (which are not as desirable and have a size greater than the fixed size). In another embodiment, screening station 320 may use two different sized screens to yield three different sized particles of OMPA output for processing through facility 300. The three different sized particles may be generically referred to as unders (particles less than size X), mids (particles ranging between sizes X and Y), and overs (particles greater than size Y), where X and Y are integers in the mm range. In some embodiments, the mids and unders may be more desirable than the overs for use in producing DRHF. The data obtained during the screening process at station 320 can be added to the customer-tied entry and can be used by a front end processor for facility 300.

The different sized groups of particles can be subject to different processes depending on which category the particles fall into at screened particle processing station 325. For example, the overs may need to be milled so that they are resized to mids before a subset of the overs (which have been cut down in size) can be combined with the mids. As another example, the unders can undergo a process that compacts the unders such that the unders are reshaped into mids. This way, a portion of the unders, which have been reshaped, can be used in combination with the mids in other parts of the DRHF preparation process. Any of these process steps may be performed at station 325.

One example process step that may be performed on midsized particles in station 325 can be a film and fiber separation step in which lighter material is separated from heavier material. The midsized particles may be directed to fall onto a series of sloped ramps while air is blown from below to separate lighter material from heavier material. The heavier material passes through the ramps on their way to a mill station, a heating station, or another station. The lighter materials, which are likely to primarily be fiber and film particles, are removed so that only the heavier materials pass through to the mill station, heating station, or other station. The lighter particles can be sent to another processing line (e.g., a BSF processing line), a composting facility, a recycling facility, or other suitable facility based on the material properties of the lighter material. For example, if the majority of the lighter material is comprised of fiber and dust, the lighter materials may be sent to a composting facility or BSF processing line. As another example, if the majority of the lighter material is fiber, the lighter materials may be sent to a recycling facility.

In some embodiments, the data obtained from each process step within screened particle processing station 325 may be monitored and logged with a user account (to the extent that such associations can be done with sufficient confidence) and/or with a front end processor for facility 300. For example, if marker tag is detected in the lighter materials, then a relatively high confidence exists for attributing lighter material data to the user account.

Screened OMPA output may be processed at sterilization station 330. Sterilization station 330 may pasteurize screened OMPA output contained therein to ensure that all pathogens are destroyed before passing on to the next processing station. Many different sterilization applications can be used to achieve pathogen destruction. In one embodiment, thermal application of heat may be applied to the OMPA output. As a specific example, a fluid bed dryer may be used to conduct batch or continuous heating of OMPA output. In another embodiment, non-thermal application may be used to destroy pathogens such as through application of gamma rays, x-rays, e-beam (high energy electrons), or microwaves. In some embodiments, a combination of thermal and non-thermal applications may be used.

Milling station 335 may mill the pasteurized OMPA output to a fixed size range. For example, milling station 335 may ensure that all particles are sized to within a fixed percentage of a predetermined size. In some embodiments, the milling process executed by milling station 335 may be performed before or after the sterilization process executed by station 330.

Mixing station 340 may perform many different mixing operations. In one embodiment, mixing station 340 may mix different batches of OMPA output that have been processed at different processing stations or lines (e.g., a midsize particle line and an undersized particle line). In another embodiment, mixing station 340 may add in feed ingredients (e.g., corn, soybean meal, dicalcium phosphate, limestone, synthetic amino acids, salt, vitamin premix, and mineral premix) that supplement the raw DRHF produced by facility 300.

Analysis station 350 may check the quality of the DRHF produced at or after any station within facility 300. In some embodiments, analysis station 350 may conduct real time analysis of the DRHF using near infrared. This can provide results for protein and several amino acids. In another embodiment, optical analysis tools may be used to evaluate the quality of DRHF. The data obtained from analysis station 350 may be stored as part of a DRHF or batch data set.

Output station 360 may prepare DRHF for shipment. For example, DRHF may be placed into sacks. The sacks may be shipped to a DRHF partner. In some embodiments, the quality of DRHF may be checked before shipment.

It should be noted that data acquisition can be performed at any one of stations 310, 315, 320, 325, 330, 335, 340, 350, and 360 and stored in the appropriate data sets. It should also be noted that although analysis station 350 is shown as existing between stations 340 and 360, analysis station 350 can be used in combination with other stations as desired. In some embodiments, one or more stations may be practiced externally to the processing facility 300. For example, the inspection station may be implemented on a vehicle designated to pick up OMPA output.

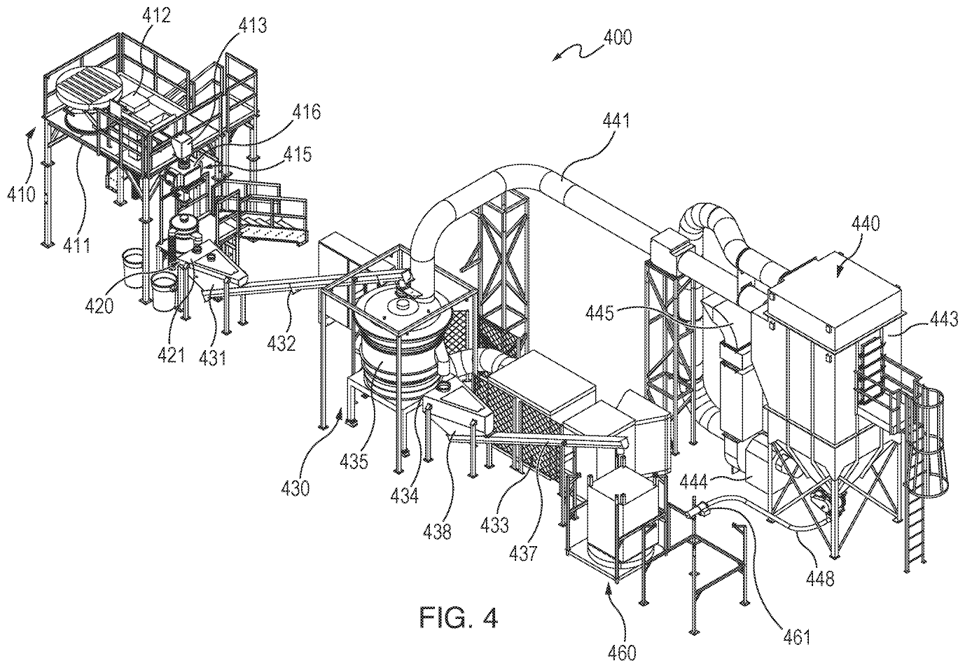

FIG. 4 shows an illustrative perspective view of a feed ingredient production facility 400 according to an embodiment. Facility 400 represents one specific implementation of facility 300 of FIG. 3. Facility 400 is shown to include six different stations to convert OMPA output to DRHF. Inspection station 410 may be used to perform inspection features discussed in connection with inspection station 310. Inspection station 410 can include inspection platform 411, inspection station equipment 412, and vibratory feeder 413. Inspection platform 411 can be a steel platform with stairs and railings. A stainless steel inspection table may exist on the platform. A loader such as Bishamon EZ Loader, which has a self-leveling pallet leveler, may also exist on the platform. Various inspection equipment 412 can reside on the inspection table. Inspection station equipment 412 can include a barcode or QR code scanner, a scale (e.g., a digital scale), camera (e.g., USB camera), a front-end device such as a tablet, laptop, or dedicated computer terminal, and inspection trays. Vibratory feeder 413 can convey OMPA output that passed inspection into gravity metal detector 416, which is part of metal removal station 415 (which can perform functions similar to metal removal station 315). Gravity metal detector 416 can detect metal particles and has the ability to temporarily redirect a material stream to remove the metal contaminated OMPA output from the process stream. All OMPA output that is not removed from the process stream flows into rotary vibroscreen 421. Vibroscreen 421 is part of screening station 420. Screening station 420 may perform screening functions like that discussed above in connection with screening station 320. Vibroscreen 421 can remove coarse particles from the process stream so that particles having a smaller size pass through to hopper 431 of sterilization station 430.

Sterilization station 430 can serve dual purpose of sterilizing OMPA output and separating finer particles from the process stream. Sterilization station 430 can perform operations of stations 325 and 330. Sterilization station 430 can include hopper 431, conveyance augur 432, fan 433, heat source 434, and fluidized bed dryer 435. Hopper 431 may have a rotary level indicator that a front end control system can use to shut off upstream equipment when hopper 431 is full. Conveyance auger 432 can transport OMPA output from hopper 431 to fluidized bed dryer 435. Fan 433 can supply air to heat source 434 to that heated air to fluidized bed dryer 435. Heat source 434 may be a gas burner that supplies process heat and sweep gas to fluidized bed dryer 435. Fluidized bed dryer 435 pasteurizes the OMPA output by killing or substantially reducing pathogens. The pasteurize OMPA, or DRHF, passes to hopper 436 and then is conveyed by auger 437 to output station 460.

Fine feed recovery station 440 may collect lighter weight particles being blown out of fluidized bed dryer 435 as the OMPA output is processed through fluidized bed dryer 435. Fine feed recovery station 440 may include fine feed recycler 443, exhaust fan 444, and filter 445. Ducting 441 routes lighter OMPA output particles that are discharged from fluidized bed dryer 435 to fine feed recycler 443. Fine feed recycler (FFR) 443 is a pulse-jet baghouse filter that captures lighter and smaller OMPA output particles that were elutriated from fluidized bed dryer 435 during heat treatment. FFR 443 can include an explosion isolation damper that is installed inline in the duct supplying FFR 443. Exhaust fan 444 pulls heated air from fluidized bed dryer 435 and then through FFR 443. Exhaust fan 444 generates a small net negative pressure in the headspace of fluidized bed dryer 435. Filter 445 can filter exhaust air exiting station 440 before it is released to an ambient environment. The collected fine feed may be routed to output station 460 via flex auger 448.

Output station 460 is operative to bag pasteurized OMPA output into bags for shipment. Output station 460 can bag the non-light materials (i.e., particles that are not captured by FFR 443) supplied by auger 437. Output station 460 can include rotary air lock 461 to convey fine feed collected in FFR 443 via flex auger 448. Flex auger 462 conveys the fine feed from a collection point inside FFR 443 to a product sack.

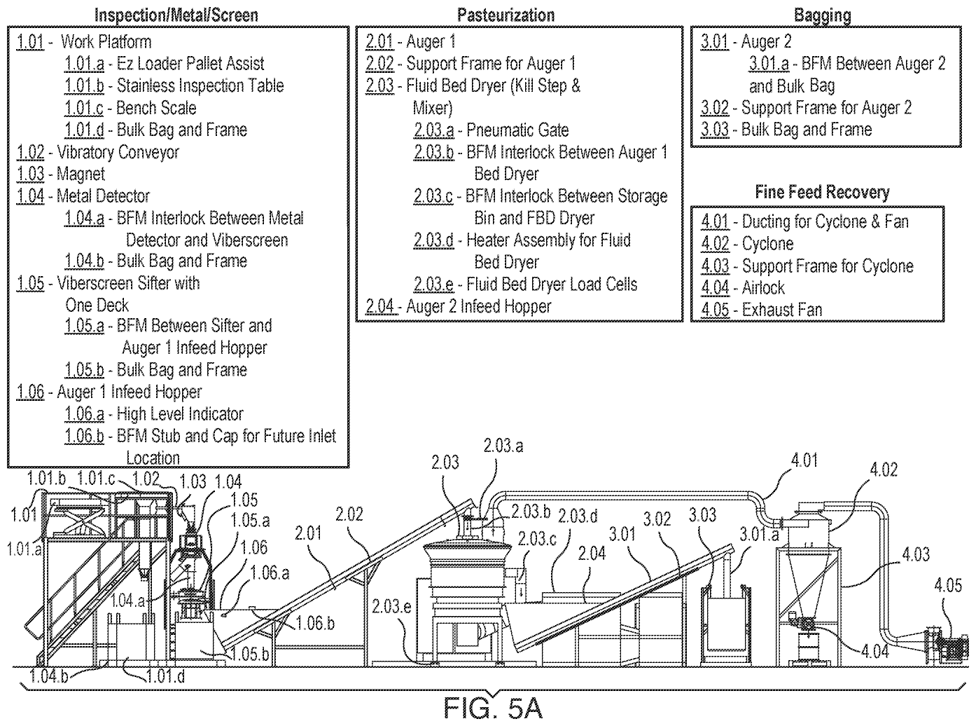

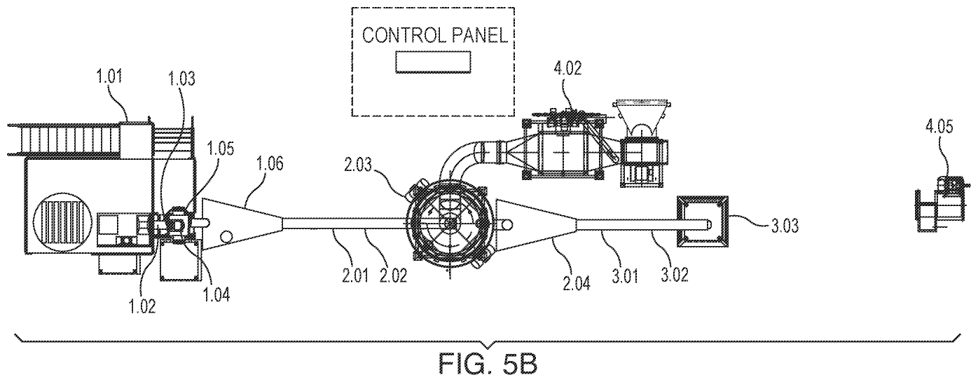

FIGS. 5A and 5B show illustrative schematic diagrams of feed ingredient production facility 500. FIG. 5A includes a legend that identifies several components of production facility 500. Many of these components are discussed in connection with FIG. 4 and therefore will not be discussed again. The identification of these components and their basic operation are self-apparent when taken in conjunction with this specification.

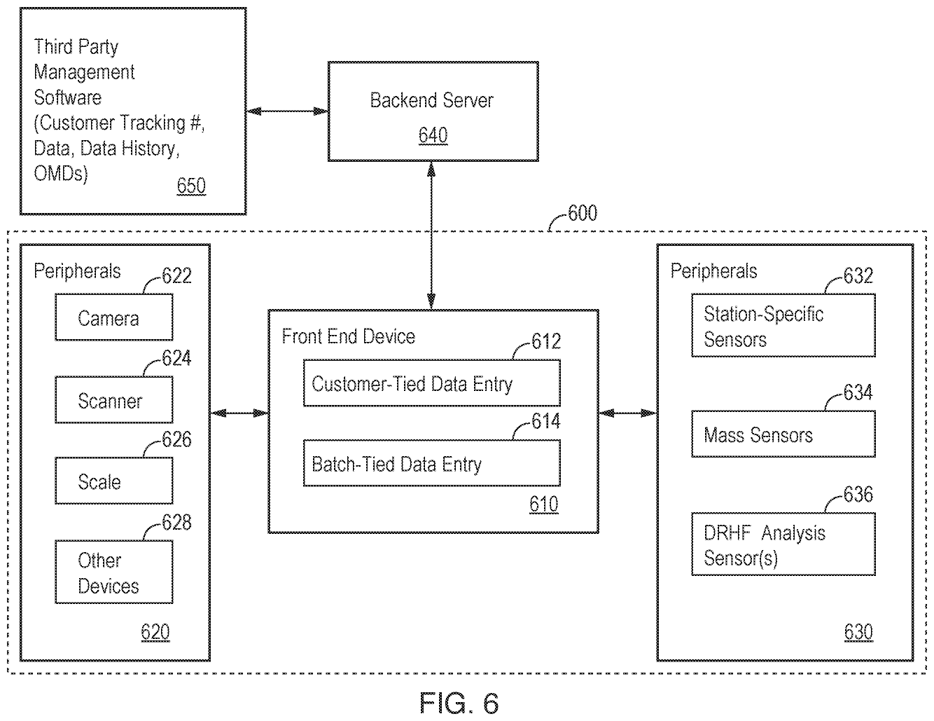

FIG. 6 shows an illustrative block diagram of data being collected by a DRHF facility according to an embodiment. Data generated at and provided to DRHF processing facilities according to embodiments discussed herein have many useful applications. The DRHF data is made accessible within a relevant timeframe to ensure it is useful for all customer-tied data applications, DRHF processing operations, and DRHF production. As shown in FIG. 6, DRHF processing facility 600 is represented by the dashed line box surrounding front end device 610, peripherals 620, and peripherals 630. Front end device 610 can communicate with backend server 640 and third party management software 650 may communicate with or operate on backend server 640. The data obtained from peripherals 620 may be data obtained by an inspection station or during an initial preprocessing stage of the process of converting OMPA output to DRHF. For example, the tracking number on a mailer can be scanned and this tracking number can be used to create customer-tied data entry 612 at front end 610. A two-way data flow may exist between front end device 610 and back end server 640, which may be running an API on an entity processor. That API may transmit data to third party management software 650. A two-way data flow may also exist between a front end associated with a DRHF partner (not shown) and back end server 640. In some embodiments, the two-way communication can enable operations conducted at the inspection station to be tailored to the specific household's inspection or customer account's history. Tailoring inspection can enable “lite-duty” (rapid-screen) inspection of OMPA output associated with customer accounts having a desirable history, thereby saving an inspection operator or robot a significant amount of inspection time. Other applications of data provided to and generated at a DRHF processing facility can include verification that mailers delivered by a third party logistics service (e.g., USPS) were received by a DRHF processing facility, establishing evidence that the OMPA output material is a food resource (rather than waste) for which proper chain of custody is maintained throughout its processing through the facility, providing feedback to users when contaminants are identified in their OMPA output, quantifying impact for users by confirming receipt of user's OMPA output and generating user specific data (e.g., mass data, nutritional data, contaminate presence, moisture data, etc.) that can be provided to users (e.g., in the form of a report), tracking DRHF facility performance metrics associated with throughput, yield, operational efficiency, quantity of product generated, turnover, work in progress, finished goods inventory, etc., provide customer support with data concerning users OMPAs and mailer use behavior, and ensure adherence to feed safety compliance requirements.

The data obtained from peripherals 630 may include data obtained from stations other than the inspection station or data obtained during conversion of the OMPA output to DRHF. Some of the data obtained from peripherals 630 may be included in customer-tied data entry 612. Other data obtained from peripherals 630 may be included in batch-tied data entry 614. Some data may be shared among customer-tied data entry 612 and batch-tied data entry 614. For example, each batch of DRHF product can be tied back to a group of customer accounts for traceability purposes.

Peripherals 620 can include camera 622, scanner 624, scale 626, other devices 628. Other device 628 can include sensors for determining various characteristics of the OMPA output, such as an olfactory sensor, a humidity sensor, a spectrometer, an infrared sensor, or any other sensor.

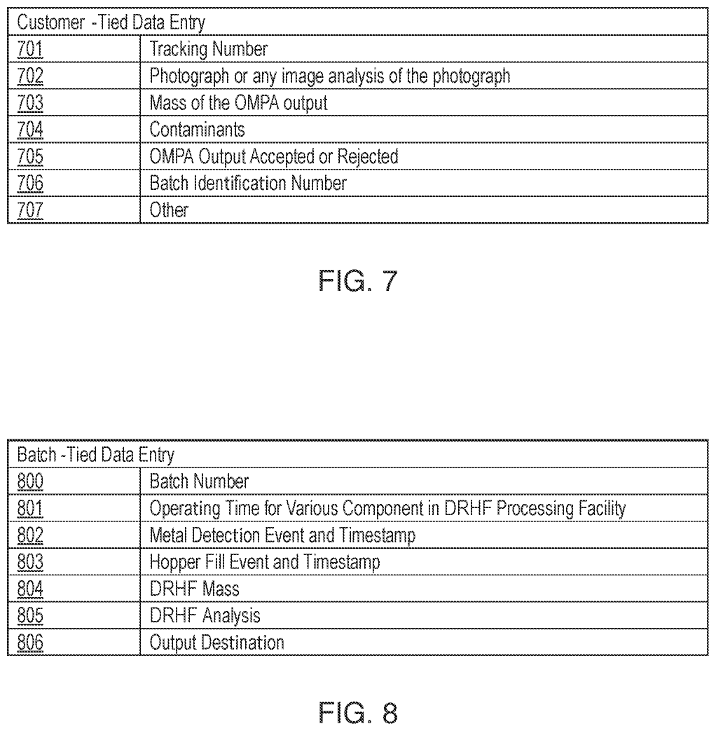

FIG. 7 shows an illustrative block diagram of customer-tied data being collected by a DRHF facility according to an embodiment. Data feature 701 relates to a tracking number of an OMPA output mailer box. The tracking number is scanned and is logged as a mailer entry into a software application running on a front end device (e.g., a tablet that receives operator inputs or a computer system that automatically logs in data features). This entry ties any inspection and metal detection data or other data to the mailer entry. Thus, any data obtained during processing of OMPA output that can be specifically tied back to a particular mailer is added to the corresponding mailer entry. All mailer-tied data can be uploaded to a backend server, which can associate the mailer entry and the mailer-tied data to a user account (e.g., a membership or OMPA associated with the user account) being maintained in backend server databases. Data feature 702 relates to a photo of the OMPA output or any image analysis of the photo. After the OMPA output is placed on to an inspection tray, a photograph may be taken thereof and stored in connection with the mailer entry by the software application. Data feature 703 relates to the mass of the OMPA output. The inspection tray can be weighed (after it has been tared) to obtain the mass value of the OMPA output. The mass value can be stored in connection with the mailer entry by the software application.

Data feature 704 relates to contaminant records that are observed in the OMPA output. An operator or machine may be able select one of more of the following categories as contaminants: 1) Wet/Oily; 2) Moldy; 3) Rocks/Inert Objects; 4) Plastics; 5) Compostable Plastics; 6) Metal/Foil; 7) Labels (e.g., produce labels); and 8) Other. In some embodiments, an operator may be able to add additional category fields with custom names. One or more of each of the categories can include quantity entry fields. This enables the operator or machine to specify a quantity level for each detected category. For example, three different quantity levels may be selected: 1) “tiny bit”; 2) “some” (e.g., a default value); and 3) “a lot”. The contaminant records are stored with the mailer entry by the software application.

Data feature 705 relates to whether the OMPA output has been rejected. Each mailer is assigned a rejection value of “not” rejected or “yes” rejected. The operator or machine evaluating the contents of the mailer may enter the rejection value in the front end device. The rejection value is stored with the mailer entry by the software application.

Data feature 706 relates to a batch identification number. Each batch can include multiple mailers. Each mailer can be assigned to a batch identification number. The software may control the value of the batch identification number, but the operator may choose to transition to a new batch identification number as needed. The batch identification number is stored with the mailer entry. The batch identification number can also be used for batch-tied entries so that data associated with batches can be stored and used as desired.

Data feature 707 may include an “other” field that enables an operator to select from a prepopulated list of notes or a text entry field that enables the operator to type in notes related to the inspection.

The data collection for the inspection stage can be attributed to in-depth data collection or lite data collection. The decision to engage in in-depth or lite data collection may depend on whether the mailer is associated with a customer account that has a favorable history of providing mailers that satisfy non-contaminant criteria or any other suitable criteria. The in-depth data collection can include the mailer tracking number, the batch number, a photograph, mass of the OMPA output, an indication of whether any contaminants are present, a detailed explanation of various sources of contamination, and other notes. Lite data collection may include the mailer tracking number, the batch number, mass of the OMPA output, an indication of whether any contaminants are present, and other notes.

After the operator or machine has finished inspection of a particular mailer, a completion step may be executed on the software application to indicate inspection of the instant mailer is complete. In another approach, if a new mailer is scanned, the software application may automatically execute the completion step. Following execution of the completion step, the software application may upload all the data associated with the mailer entry to a back end server.

Peripherals 630 can include station specific sensor 632, mass sensors 634, DRHF analysis sensors 636, and other devices. Station specific sensor 632 may include sensors that are germane to a particular station. For example, a metal detection station may include a metal detection sensor. A metal detection event may be recorded by a metal detection sensor and provided to front-end device 610. As another example, various components within processing facility 600 may have sensors that provide data to front end device 610 or other control panel. For example, a hopper may transmit data indicating that it is full. Mass sensors 634 may provide mass data to front end 610. Mass sensors 634 may be included with various stations such as the sterilization station and the output station. DRHF analysis sensor(s) 636 can analyze DRHF at the sterilization station, output station, or at a location existing between stations.

FIG. 8 shows an illustrative block diagram of batch-tied data being collected by a DRHF facility according to an embodiment. The batch-tied data may relate to several different process oriented data features. These process oriented data features may be tied to a batch of OMPA output and thus all collected data may be batch-tied to a batch entry being stored in a database. A front-end controller or device may be running software that controls and monitors the operation of various stations within a DRHF facility and can store the data obtained during processing of OMPA output to DRHF. In some embodiments, the data can be provided to the software program running on the front end device, and this data may be uploaded to back end server. Data feature 800 relates to a batch number. Data feature 801 relates to operating time of one or more components of the DRHF facility. For example, the operating time (e.g., hours of operation) of various components (e.g., metal detector, screening machine, augers, sterilization system, fine feed particle recovery system) may be monitored and logged and stored. Data feature 802 relates to timestamps for each time a metal is detected in a batch of OMPA output. Data feature 803 relates to timestamps for each time a hopper reaches a high level fill limit. Data feature 804 relates to mass of DRHF residing in in one more stations of the DRHF processing facility. For example, mass values of contents contained in the sterilization station can be obtained when the sterilization process is complete and the contents contained therein are ready to be transferred to another station. The sterilization station may sit on load cells that are able to measure mass. As another example, the mass of the sack or bag containing DRHF produced by the DRHF facility may be measured at the output station.

Data feature 805 relates to analysis of DRHF at one or more stations within DRHF facility or during transfer between stations. The analysis may provide nutritional data (e.g., protein, carbohydrate, fat, salt, and other content), moisture, and other measurable data of the DRHF. This data may be obtained at the output station, for example. Data feature 806 relates to destination for the DRHF. For example, the DRHF partner receiving the DRHF.

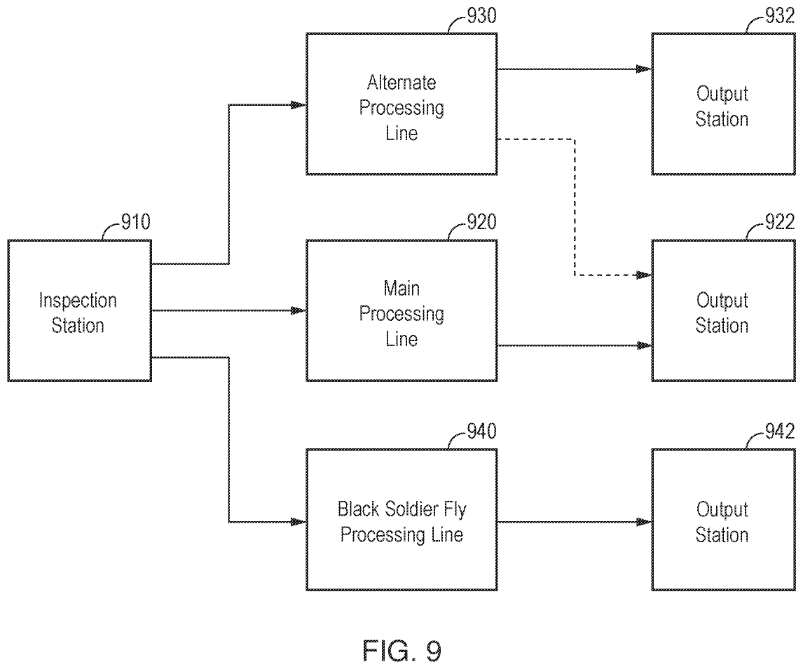

FIG. 9 shows an illustrative block diagram of a system using multiple processing lines to convert OMPA output to DRHF according to an embodiment. FIG. 9 shows inspection station 910, main processing line 920, alternative processing line 930, black soldier fly processing line 940, output station 922, output station 932, and output station 942. Main processing line 920 may refer to a preferred line for converting optimal OMPA output to DRHF. Line 920 may be similar to the embodiment shown FIG. 4. Alternative line 930 may in some embodiments be a replica of line 920. In another embodiment, alternative line 930 may be configured to handle the type OMPA output it is expected to process. For example, OMPA output that classified as undersized may be routed to and processed in alternative line 930. Black soldier fly processing line 940 may be a facility for enabling flies or other insect that lays eggs that hatch as larvae to breed and lay eggs so that the larvae consume the OMPA output. The larvae are collected as a relatively high quality protein source. Line 940 may be used to process OMPA output that does not meet inspection criteria, sized in a manner that cannot be processed by lines 920 or 930, or are contaminated. At inspection station 910 or at a screening station (not shown) OMPA output is routed to one of lines 920, 930, and 940 for converting the OMPA output to DRHF. Output stations 922, 932, 942 are designed to handle shipment, bagging, or other output operation of DRHF. In some embodiments, alternative processing line 930 may send DRHF to output station 922. It should be understood that additional processing lines may be added and that existing processing lines may be omitted. In some embodiments, a process line (e.g., black soldier fly processing line) may be contained in a separate facility than the other processing lines.

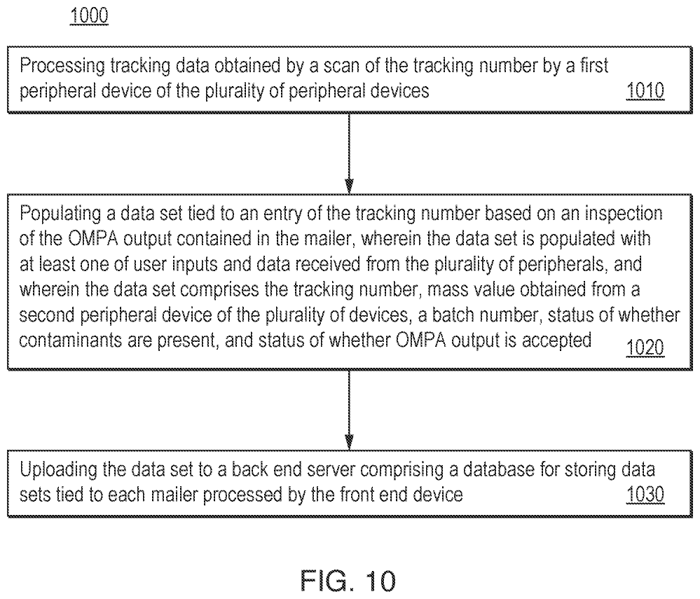

FIG. 10 shows illustrative process 1000 according to an embodiment. Process 1000 may be implemented in a front end device that receives user input from an operator and data from a plurality of peripheral devices operating in a processing facility operative to convert OMPA output to dried recovered household food. A mailer can include a tracking number and OMPA output produced by an OMPA. Process 1000 can process tracking data obtained by a scan of the tracking number by a first peripheral device of the plurality of peripheral devices, at step 1010. A data set tied to an entry of the tracking number can be populated based on an inspection of the OMPA output contained in the mailer, at step 1020. The data set can be populated with at least one of user inputs and data received from the plurality of peripherals. The data set can include the tracking number, mass value obtained from a second peripheral device of the plurality of devices, a batch number, status of whether contaminants are present, and status of whether OMPA output is accepted. The data set can also include a photograph of the OMPA output. The data set can include a plurality of contamination sources, wherein each contamination source is identified as present or not present, and optionally can include quantitative values. For example, the plurality of contamination sources can be selected from a list including wet/oily, mold, rock and inert object, compostable plastic, paper, metal or foil, and produce label contaminants. When the OMPA output is accepted, the OMPA output can be routed to a primary processing line that is operative to convert the OMPA output to DRHF, and wherein when the OMPA output is not accepted, routing the OMPA output to one of a compost processing line, a black soldier fly larva processing line, and an alternative processing line that subjects the OMPA output to extra evaluation scrutiny before allowing the OMPA output to be converted to DRHF. At step 1030, the data set can be uploaded to a back end server comprising a database for storing data sets tied to each mailer processed by the front end device.

It should be appreciated that the steps shown in FIG. 10 are merely illustrative and that additional steps may be added, steps may be omitted, and that the order of the steps can be rearranged. For example, process 1000 can obtain a customer account based on the processed tracking data, access the customer account to assign a high or low risk factor to the OMPA output contained in the mailer, and instruct the operator or a machine to route the mailer to a primary processing line or an alternative processing line based on whether the OMPA output has been assigned a high or low risk factor. The alternative processing line can subject the OMPA input to extra inspection scrutiny than the primary processing line.

As another example, process 1000 can obtain a customer account based on the processed tracking data, access the customer account to obtain OMPA data from the OMPA that produced the OMPA output contained in the mailer, compare a subset of the data set to a subset of the OMPA data to determine whether at one discrepancy exists that exceeds a tolerance threshold, and direct the OMPA output to a primary processing line or an alternative processing line based on the comparison. The subset of the OMPA data includes a mass value of the OMPA output removed from the OMPA and timestamp of when OMPA output is removed from the OMPA, and wherein the subset of the data set includes a mass value of the OMPA output removed from the mailer and a timestamp of when the OMPA output is removed from the mailer.

As another example, process 1000 can insert a marker into a first OMPA output at an inspection station of the plurality of stations, wherein the first OMPA output passes through a subset of the plurality of stations as the first OMPA output is converted to DRHF, and wherein the marker enhances a statistical probability that the first OMPA output is traceable to a particular mailer, identify an issue with the first OMPA output at one of the plurality of stations, update the data set associated with the first OMPA output to incorporate the identified issue, and uploading the updated data set to the back end server.

As another example, process 1000 can receive qualitative and/or quantitative data from the DRHF contained in the sterilization station or in the shipping bag and upload that data to the back end server for inclusion into the batch data set.

As another example, process 1000 can include, in the batch data set, a DRHF utilization partner identified to receive the shipping back containing the DRHF, determine a plurality of mailers used in the batch, generate a report for each of a plurality of customer accounts associated with the determine plurality of mailers used in the batch, wherein the report specifies the DRHF utilization partner, and provide the report to each of the plurality of customer accounts.

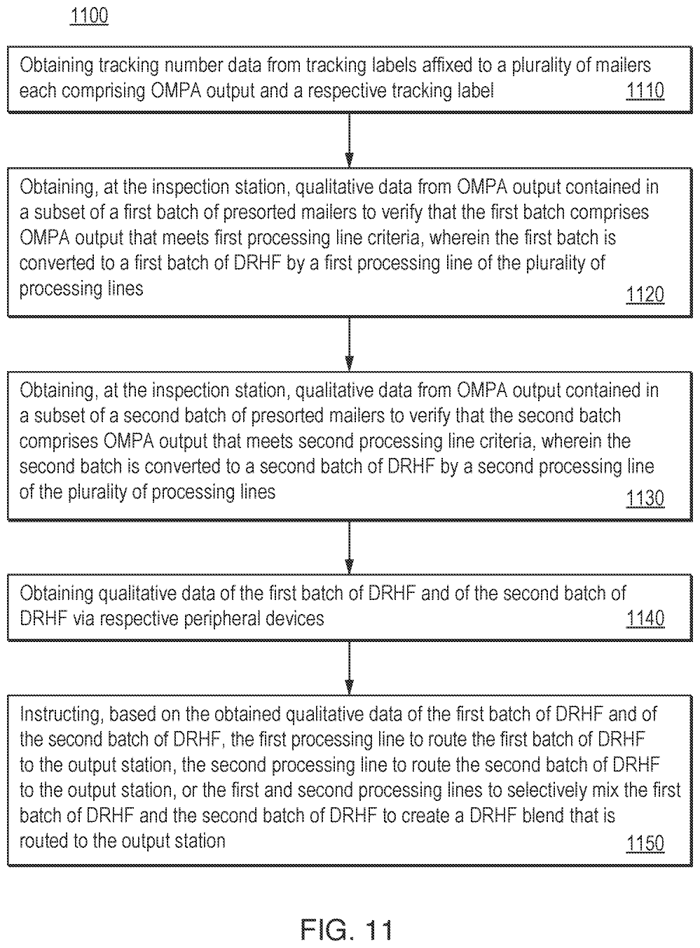

FIG. 11 shows illustrative process 1100 according to an embodiment. Process 1100 may be implemented in a front end device that receives data from peripheral devices operating in a processing facility. The processing facility can include an inspection station, a plurality of processing lines each operative to convert OMPA output to DRHF, and an output station. Process 1100 can begin at step 1110 by obtaining tracking number data from tracking labels affixed to a plurality of mailers each comprising OMPA output and a respective tracking label. At step 1120, process 1100 can obtain, at the inspection station, data (e.g., qualitative data) from OMPA output contained in a subset of a first batch of presorted mailers to verify that the first batch comprises OMPA output that meets first processing line criteria, wherein the first batch is converted to a first batch of DRHF by a first processing line of the plurality of processing lines. If desired, the tracking number data can be correlated to a customer account comprising customer account data related to the OMPA output contained in the mailer associated with the customer account and the plurality of mailers can be presorted into a plurality of batches each designated for one of the plurality of processing lines, wherein the presorting is based on the customer account data tied to the respective tracking number. The customer account data can include OMPA output history of at least one mailer processed at the processing facility. In addition, the customer account data can include an accounting of OMPA input used to produce the OMPA output received in the mailer containing the OMPA output.

At step 1130, process 1100 can obtain, at the inspection station, data from OMPA output contained in a subset of a second batch of presorted mailers to verify that the second batch comprises OMPA output that meets second processing line criteria, wherein the second batch is converted to a second batch of DRHF by a second processing line of the plurality of processing lines.

At step 1140, process 1100 can obtain data of the first batch of DRHF and of the second batch of DRHF via respective peripheral devices. At step 1150, process 1100 can instruct, based on the obtained data of the first batch of DRHF and of the second batch of DRHF, the first processing line to route the first batch of DRHF to the output station, the second processing line to route the second batch of DRHF to the output station, or the first and second processing lines to selectively mix the first batch of DRHF and the second batch of DRHF to create a DRHF blend that is routed to the output station.

It should be appreciated that the steps shown in FIG. 11 are merely illustrative and that additional steps may be added, steps may be omitted, and that the order of the steps can be rearranged. For example, process 1100 can receive a DRHF order having a first set of requirements and wherein the instructing is executed such that first batch of DRHF, the second batch of DRHF, or the DRHF blend is output via the output station to satisfy the first set of requirements of the DRHF order.

As yet another example, the processing facility can include a supplement station operative to add feed ingredient supplements to any one of the plurality of processing lines. Process 1100 can instruct the supplement station to add one or more feed ingredient supplements to the first batch of DRHF, the second batch of DRHF, or the DRHF blend to produce an enhanced DRHF.

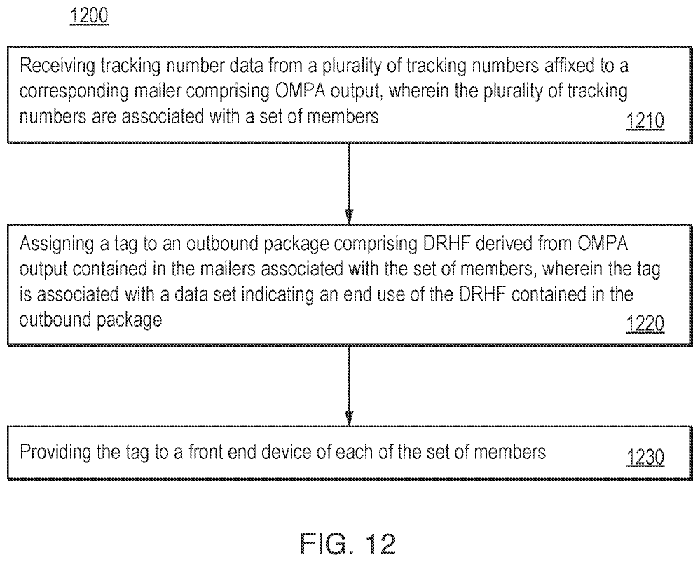

FIG. 12 shows illustrative process 1200 according to an embodiment. Process 1200 may be implemented in a front end device that receives data from peripheral devices operating in a processing facility. The processing facility can include an inspection station, a processing line operative to convert OMPA output to DRHF, and an output station. Process 1200 can begin step 1210 by receiving tracking number data from a plurality of tracking numbers affixed to a corresponding mailer comprising OMPA output. The plurality of tracking numbers are associated with a set of members. At step 1220, process 1200 can assign a tag to an outbound package comprising DRHF derived from OMPA output contained in the mailers associated with the set of members. The tag is associated with a data set indicating an end use of the DRHF contained in the outbound package. The tag may be non-ferrous or non-metallic so that it does not get rejected by a metal detection station. At step 1230, the tag can be provided to a front end device of each of the set of members. This way, if the member so desires, he or she can click on a link associated with the tag and see where his or her OMPA output has gone (e.g., which farm or class of animals is using the DRHF derived from the OMPA output.

It should be appreciated that the steps shown in FIG. 12 are merely illustrative and that additional steps may be added, steps may be omitted, and that the order of the steps can be rearranged.

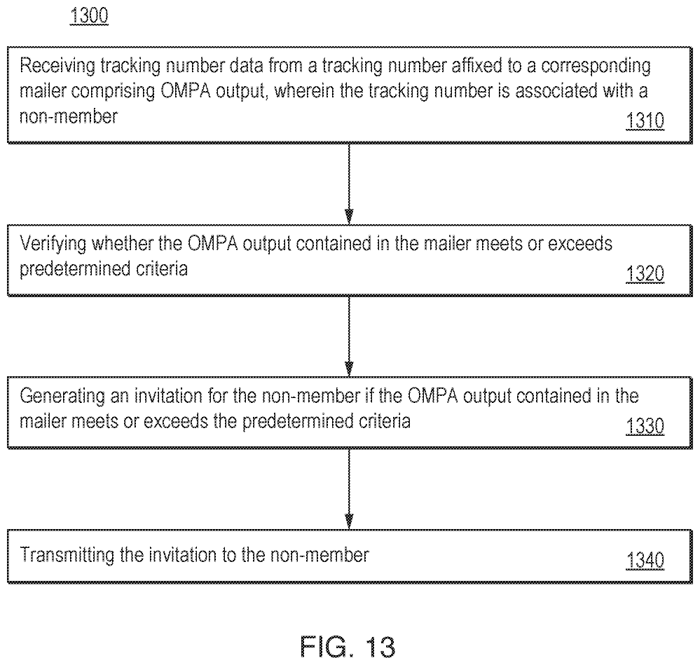

FIG. 13 shows illustrative process 1300 according to an embodiment. Process 1300 may be implemented in a front end device that receives data from peripheral devices operating in a processing facility. The processing facility can include an inspection station, a processing line operative to convert OMPA output to DRHF, and an output station. Process 1300 can begin at step 1310 by receiving tracking number data from a tracking number affixed to a corresponding mailer comprising OMPA output, wherein the tracking number is associated with a non-member. Process 1320 can verify whether the OMPA output contained in the mailer meets or exceeds predetermined criteria and generate an invitation for the non-member if the OMPA output contained in the mailer meets or exceeds the predetermined criteria, at step 1330. Process 1300 can transmit the invitation to the non-member at step 1340.

It should be appreciated that the steps shown in FIG. 13 are merely illustrative and that additional steps may be added, steps may be omitted, and that the order of the steps can be rearranged.

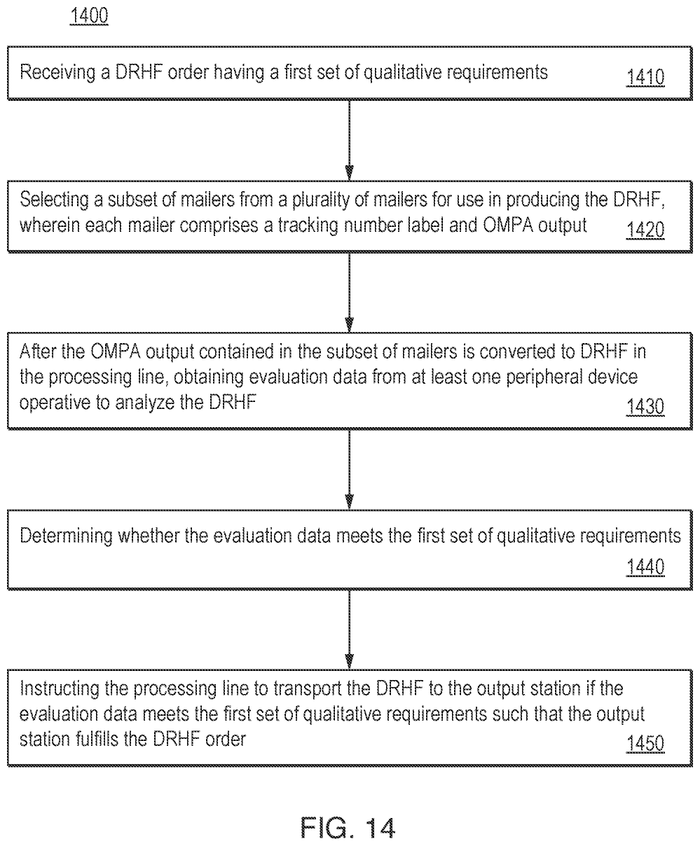

FIG. 14 shows illustrative process 1400 according to an embodiment. Process 1400 may be implemented in a front end device that receives data from peripheral devices operating in a processing facility. The processing facility can include an inspection station, a processing line operative to convert OMPA output to DRHF, and an output station. Process 1400 can begin at step 1410 by receiving a DRHF order having a first set of requirements. Process 1400 can obtain tracking number data from a tracking number label and access customer account data associated with the tracking number data, wherein the customer account data serves as a basis for selecting the subset of mailers.

At step 1420, process 1400 can select a subset of mailers from a plurality of mailers for use in producing the DRHF, wherein each mailer includes a tracking number label and OMPA output. After the OMPA output contained in the subset of mailers is converted to DRHF in the processing line, process 1400 can obtain evaluation data from at least one peripheral device operative to analyze the DRHF. Process 1400 can determine whether the evaluation data meets the first set of requirements (at step 1430) and instruct the processing line to transport the DRHF to the output station if the evaluation data meets the first set of requirements such that the output station fulfills the DRHF order (at step 1440).

The processing facility can include a supplement station operative to add feed ingredient supplements to the processing line. If the evaluation data does not meet the first set of requirements, process 1400 can determine a compensation set of ingredients required to adjust composition of the DRHF to meet the first set of requirements, instruct the supplement station to add one or more feed ingredient supplements according to the compensation set of ingredients to the DRHF contained in the processing line to provide compensated DRHF, and instruct the processing line to transport the compensated DRHF to the output station such that the output station fulfills the DRHF order.

It should be appreciated that the steps shown in FIG. 14 are merely illustrative and that additional steps may be added, steps may be omitted, and that the order of the steps can be rearranged.

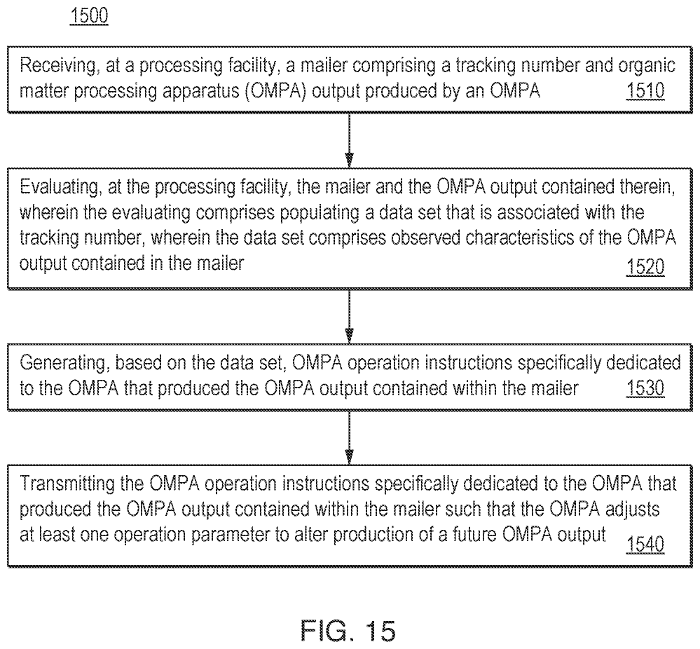

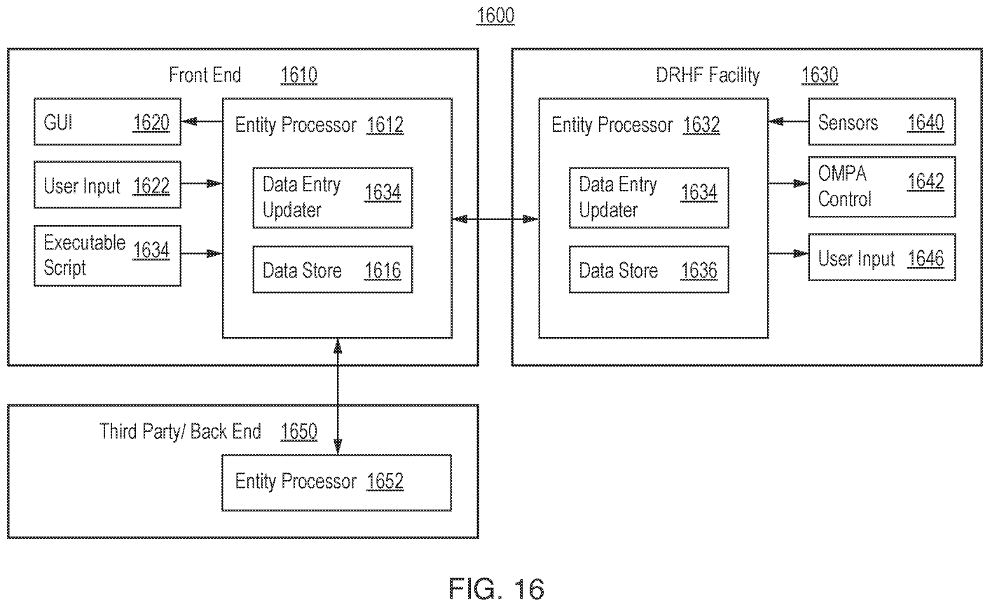

FIG. 15 shows illustrative process 1500 according to an embodiment. Process 1500 can begin at step 1510 by receiving, at a processing facility, a mailer including a tracking number and (OMPA output produced by an OMPA. At step 1520, process 1500 can evaluate, at the processing facility, the mailer and the OMPA output contained therein. The evaluation can populate a data set that is associated with the tracking number, and the data set can include observed characteristics of the OMPA output contained in the mailer. The observed characteristics can include a humidity value of the OMPA output that exceeds a predetermined humidity value. The OMPA operation instructions can include an updated setpoint temperature for a heater that operates during a processing cycle of the OMPA. The OMPA operation instructions can include an updated runtime for the heater during the processing cycle of the OMPA. At step 1530, process 1500 can generate, based on the data set, OMPA operation instructions specifically dedicated to the OMPA that produced the OMPA output contained within the mailer. At step 1540, process 1500 can transmit the OMPA operation instructions specifically dedicated to the OMPA that produced the OMPA output contained within the mailer such that the OMPA adjusts at least one operation parameter to alter production of a future OMPA output.

It should be appreciated that the steps shown in FIG. 15 are merely illustrative and that additional steps may be added, steps may be omitted, and that the order of the steps can be rearranged.

Embodiments described herein relate to systems and methods for processing OMPA output at a DRHF processing facility, obtaining customer-tied data sets of the OMPA output, obtaining batch-tied data sets related to batches of OMPA output and DRHF derived therefrom, maintaining chain of custody of OMPA output and DRHF to satisfy food regulations, providing feedback to select OMPAs to adjust operation of said OMPA, generating reports for customers based on received OMPA output and DRHF derived therefrom, and obtaining other data pertaining to the operation of the DRHF facility. These systems and methods can be implemented in a software platform for storing and retrieving platform-level aggregate data objects (herein “entities”) that may be created, modified, or updated. An entity may be updated, created, or modified by a user operating a frontend of a software platform, an administrator operating a frontend or a backend of the software platform, by machines or robots operating in the DRHF facility, or by operation of the software platform itself (e.g., an automatic or scheduled update). These examples are not exhaustive; a person of skill in the art may appreciate that a platform-level data object may be created, modified, or updated in a number of suitable ways and/or in response to a number of inputs or events.

A software platform entity (or “entity”) as described herein can be a meta object formed, built, structured, or otherwise based on a number of lower-level data objects which, in turn, may be stored in one or more data stores, databases, or tables of a software platform. In another non-limiting phrasing, an entity or “data entity” as described herein is (typically) a platform-level object or high-order object that links to, aggregates, combines, or is otherwise associated with or based on one or more lower-level data objects.

For example, the software platform can be data collection application having a front end device that operates in the DRHF facility and a backend that operates on a server and that provides data for third party management software to perform, for example, data recall and data analysis. For convenience, the data application may be referred to herein as the DRHF application. As another example, a different software platform can be an OMPA application having a front end that operates on a mobile device and a backend that operates on a server. The server may be the same back end server the data collection application can communicate with. The frontend may be able to communicate directly with an OMPA via a wireless connection (e.g., Bluetooth or Wi-Fi) or indirectly with the OMPA via another wireless connection (e.g., Wi-Fi via a router). Additional details on the OMPA application and the software platform controlling data and instruction flow between the OMPA and a back end server can be found for example, in commonly owned U.S. Patent Application No. 63/478,948, filed Jan. 8, 2023, the disclosure of which is incorporated herein in its entirety.

The DRHF application can present, for example, several data entry entities that can be associated with text content, time content, user interface content, metadata, files, and so on each of which may be stored in different tables, databases, data stores, memory, and so on. In this example, the data entry entities may define different classes of data being observed by and input by an operator, robots, or peripherals as part of operation of the DRHF facility.

As another example, the DRHF may present a customer-tied data entry entity that can be associated with text content, status icons, user interface content, metadata, etc. each of which may be stored in different tables, databases, data stores, or memory. In this example, the customer-tied data entry can show data entry points for a particular mailer and may also display historical information related to the customer. Moreover, the customer-tied data entry entity may show data generated by the OMPA that supplied the OMPA input contained in a mailer.

As yet another example, the DRHF application may present a batch-tied data entry entity that can be associated with text content, status icons, user interface content, metadata, etc. each of which may be stored in different tables, databases, data stores, or memory. The batch-tied data entry entity can show data entry points of a batch of OMPA, various DRHF processing control information (e.g., machine runtimes, hopper fill events, etc.), and data related to DRHROM (e.g., nutritional information, IR data, etc.). Provisions may be made to tie batch data entries to a specific customer-tied data entry.

The DRHF application can present many different entities that are associated with a variety of text content, graphics, user interface elements, metadata, files, etc. that are stored as appropriate for fast retrieval or updates thereof. For example, other exemplary entities can include a generate report entity, an upload data entity, and request data entity. Many of the entities presented by the DRHF application may utilize data obtained from one or more peripherals device (e.g., sensors) located at various stations within the DRHF facility or obtained from operator inputs.

One or more entities presented in the DRHF application may include functional frontend-executable script elements (e.g., JavaScript™ scripts, whether imported, inline, or tagged within script tags) that provide responsive functionality for one or more user interface elements. For example, when a user interacts with a user interface element tied to a frontend-executable script element, that script element can be executed, and data can be communicated with the back end. For example, after an operator or robot has populated a data set, the operator can press a “save” button save the data. After the “save” button is pressed, this may activate the underlying script element by causing the application to communicate the saved data to the back end server.

For simplicity of description and illustration, endpoints to which an entity may be served or otherwise provided by a software platform as described herein are referred to, collectively, as “data consumers” or “entity consumers” or more generally, “consumers” of entity data. In this manner, a software platform as described herein can be communicably coupled to one or more user-consumers of data and, additionally, to one or more non-user consumers of data. For simplicity of description, the examples that follow reference constructions in which a consumer is a non-user consumer, but it may be appreciated that this is merely one non-exhaustive example.

In addition, in some embodiments, a software platform may be configured to support guaranteed delivery of computed full states of entities to one or more consumers. As used herein, the term “full state” or “full computed state” refers to a structured data representation of a particular entity, incorporating information as appropriate from all associated data objects. For example, a full computed state of any entity related to customer-tied data or batch-tied data may be a single JSON object or HTML file that incorporates all inline multimedia, text, styles, scripts, and so on associated with that entity. In a more broad phrasing, a full computed state of any data entity represent a snapshot of a particular mailer or a batch of mailers.

FIG. 16 shows illustrative block diagram of software platform 1600 that leverages entity processors, as described herein, to ensure coordinated display of GUI pages with appropriate overlays, icons, and status information reflective of data entry and collection with respect to OMPA output and DRHROM and executing client application-executable script elements to process such data on a front end client application, in addition to coordinating exchange of information with a back end client application according to an embodiment. As shown, software platform 1600 can include front end 1610, DRHF facility 1630, and third party/back end 1650. Front end 1610 can represent the front end of an application running on a device such as, for example, a mobile smartphone, tablet, or computer. DRHF facility 1630 can represent various software and hardware components of a DRHF facility. Back end 1650 can represent a backend server that communicates with the front end or a DRHF partner (not shown). Each of front end 1610, DRHF facility 1630, and back end 1650 can implement a respective entity processor 1612, 1632, and 1652 for coordinating data collection/transfer of the front end, DRHF facility, and back end. Entity processor 1612, 1632, and 1652 may be responsible for transferring information such as status information among front end 1610, DRHF facility 1630, and back end 1650 such that the appropriate entity processor can implement the necessary changes, if needed, in the software and/or hardware settings.

Entity Processor 1612 can include data entry updater 1614 and data store 1616. Data entry updater 1614 can be operative to process data inputs received from an operator or a peripheral is updated and maintained at the front end. For example, data entry updater 1614 may receive data from entity processor 1632, and based on that received state information, can populate the appropriate data set, and display the data on the front end as GUI 1620. The GUI may be derived from page format tree that is retrieved from data store 1616. For example, components of the GUI page format tree can include status identifier(s), icon(s), overlay(s), user interface element(s), and client application-executable scripts, many or all of which may be stored in data store 1616. Front end 1610 can process user input 1622, which in response thereto, entity processor 1612 can update GUI 1620 and populate a data entry field. If user input 1622 is received in connection with executable script 1624, entity processor 1612 may relay the instruction associated with executable script 1624 to entity processor 1632 of OMPA 1630 or entity processor 1652 of back end 1650.

Referring now to DRHF 1630, entity processor 1632 can include data entry updater 1634 and data store 1636. Data entry updater 1634 can be operative to ensure that any data obtained from sensors 1650, control 1642, or user input 1646 is updated and relayed to the front end 1610.

OMPA 1630 may include sensors 1640 (e.g., mass, humidity, temperature, VOC sensor, IR sensor, nutritional analysis, camera, etc.) that provide data to entity processor 1632. Some of this data or analyzed version thereof may be provided to front end 1610 for display as part of a GUI page and for entry into a data set.

Third party/Back end 1650 may include entity processor 1652 to coordinate data exchanges with front end 1610. For example, third party management software may communicate with an OMPA (not shown) or a front end device associated with a user of the OMPA based on data received from front end device 1610.

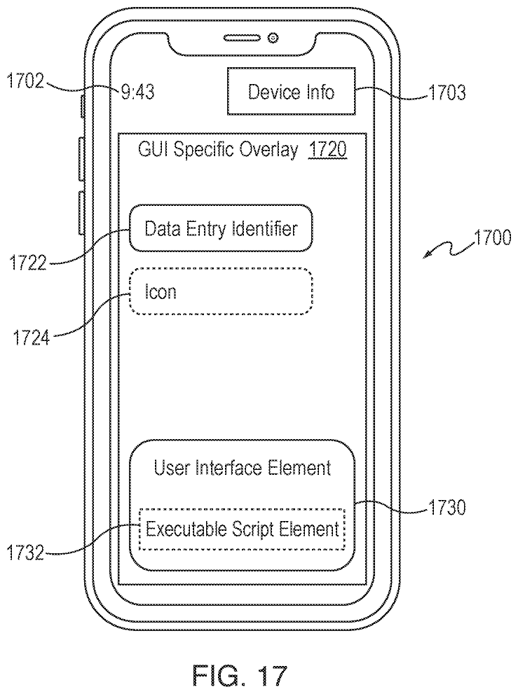

FIG. 17 shows an illustrative screen shot of a front end application being implemented on a device 1700 according to an embodiment. Screen 1701 shows time 1702, device information 1703 (e.g., battery remaining, Wi-Fi strength, etc.), and GUI specific overlay 1720. GUI specific overlay 1720 may be specific to the entity being presented on the front end of the software platform. Overlay 1720 may include graphics and text that are contextually related to the entity page being displayed. Overlay 1720 may include data entry identifier 1722, optional icon 1724, user interface element 1730 and optional executable script element 1732. Data entry identifier 1722 may succinctly identify a data entry category (e.g., tracking number). Icon 1724 may be a symbol that indicates information related to identifier 1722. More than one data entry identifier 1722 may be displayed. User interface element 1730 may be a user selectable element that can cause the GUI page to change in response to user interaction therewith. For example, in one embodiment, selection of user interface element may cause the GUI page to transition to a new GUI page. In some embodiments, an executable script element 1732 may be associated with a user interface element. This way, when a user interacts with the user interface element, the interaction can trigger execution of the script element associated with that user interface element.

The content of the GUI page presented on screen 1701 is based on the GUI page tree as discussed above, and the entity processor (e.g., entity processor 1612) may be responsible for rendering the GUI page according to the GUI page tree for the specific entity being presented.

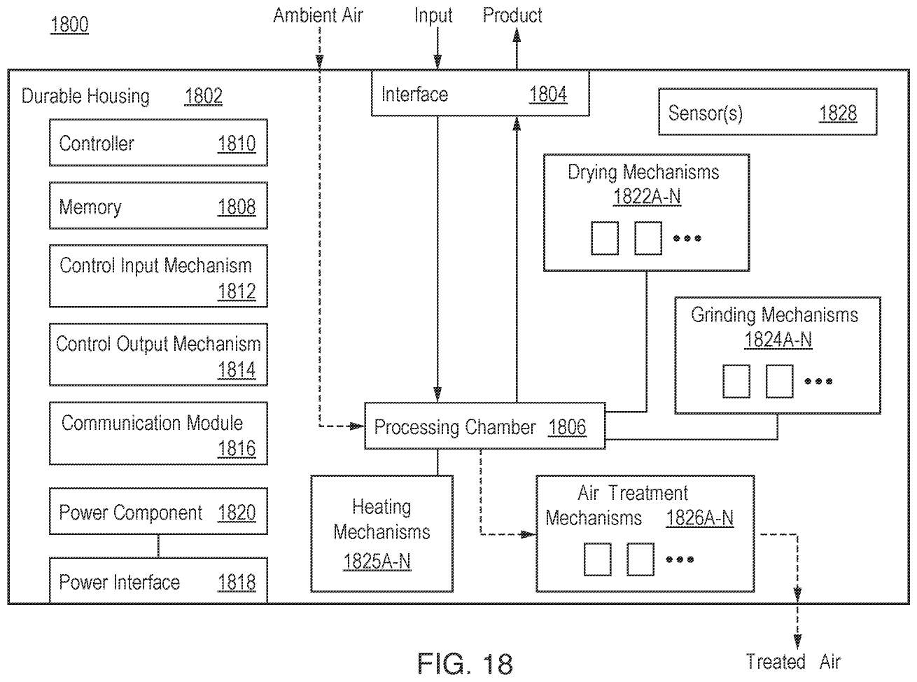

FIG. 18 includes a high-level illustration of a OMPA 1800 in accordance with various embodiments. OMPA 1800 may have a durable housing 1802 with an interface 1804 through which a processing chamber 1806 can be accessed. The interface 1804 may serve as the ingress interface through which OMPA input can be deposited into the processing chamber 1806 and the egress interface through which the product can be retrieved from the processing chamber 1806. The durable housing 1802 may take the form of a roughly cylindrical container that has an aperture along its top end.

Instructions for operating OMPA 1800 may be stored in a memory 1808. Memory 1808 may include any suitable type of storage medium, such as static random-access memory (SRAM), dynamic random-access memory (DRAM), electrically erasable programmable read-only memory (EEPROM), flash memory, or registers. In addition to storing instructions that can be executed by controller 1810, memory 1808 can also store data that is generated by OMPA 1800. For example, values generated by one or more sensors 1828 included in OMPA 1800 may be stored in memory 1808 in preparation for further analysis. These values may relate to characteristics (e.g., humidity or temperature) of the air traveling through OMPA 1800, and insights into the OMPA input contained in the processing chamber 1806 can be gained through analysis of these values. Note that memory 1808 is merely an abstract representation of a storage environment. Memory 1808 could be comprised of actual integrated circuits (also referred to as “chips”). When executed by a controller 1810, the instructions may specify how to control the other components of OMPA 1800 to produce OMPA output from OMPA input in the processing chamber 1806. The controller 1810 may include a general purpose processor or a customized chip (referred to as an “application-specific integrated circuit” or “ASIC”) that is designed specifically for OMPA 1800.

Generally, OMPA 1800 is able to operate on its own. Assume, for example, that OMPA 1800 determines that OMPA input has been deposited into the processing chamber 1806 based on measurements output by a weight sensor (also referred to as a “mass sensor”), as further discussed below. In response to such a determination, OMPA 1800 may initiate processing of the OMPA input. Note, however, that the OMPA input need not necessarily be processed immediately. For example, OMPA 1800 may not dry and then grind the OMPA input until a given criterion (e.g., time of day, weight of OMPA input, etc.) or combination(s) of various criteria is/are satisfied.

While OMPA 1800 may be able to operate largely, if not entirely, on its own, there may be some situations where input from a user will be helpful or necessary. For example, the user may want to indicate when processing should be temporarily halted so that additional OMPA input can be added to the processing chamber 1806. As another example, the user may request that an operation be initiated or halted. For instance, the user could opt to initiate a “drying cycle” if the ambient environment is expected to be vacant, or the user could opt to halt a “grinding cycle” if the ambient environment is expected to be occupied. The various cycles of OMPA 1800 are discussed in greater detail below.

As shown in FIG. 18, OMPA 1800 may include a control input mechanism 1812 (also referred to as a “data input mechanism” or simply “input mechanism”) with which the user can interact to provide input. Examples of input mechanisms include mechanical buttons and keypads for tactile input, microphones for audible input, scanners for visual input (e.g., of machine-readable codes, such as barcodes or Quick Response codes), and the like. OMPA 1800 may also include a control output mechanism 1814 (also referred to as a “data output mechanism” or simply “output mechanism”) for presenting information to inform the user of its status. For example, the control output mechanism 1814 may indicate the current cycle (e.g., whether OMPA input is being processed, or whether product is ready for retrieval), connectivity status (e.g., whether OMPA 1800 is presently connected to another electronic device via a wireless communication channel), and the like. One example of an output mechanism is a display panel comprised of light-emitting diodes (LEDs), organic LEDs, liquid crystal elements, or electrophoretic elements. In embodiments where the display panel is touch sensitive, the display panel may serve as the control input mechanism 1812 and control output mechanism 1814. Another example of an output mechanism is a speaker that is operable to output audible notifications (e.g., in response to a determination that the product is ready for retrieval).

Some embodiments of OMPA 1800 are able to communicate with other electronic devices via wireless communication channels. For example, a user may be able to interact with OMPA 1800 through a control platform (not shown) that is embodied as a computer program executing on an electronic device. In such embodiments, OMPA 1800 may include a communication module 1816 that is responsible for receiving data from, or transmitting data to, the electronic device on which the control platform resides. The communication module 1816 may be wireless communication circuitry that is designed to establish wireless communication channels with other electronic devices. Examples of wireless communication circuitry include chips configured for Bluetooth®, Wi-Fi®, ZigBee®, LoRa®, Thread, Near Field Communication (NFC), and the like.

OMPA 1800 may include a power interface 1818 (also referred to as a “power port” or “power jack”) that is able to provide main power for the drying and grinding functionality, as well as power for the other components of OMPA 100, as necessary. The power interface 1818 may allow OMPA 1800 to be physically connected to a power source (e.g., an electrical outlet) from which power can be obtained without limitation. Alternatively, the power interface 1818 may be representative of a chip that is able to wirelessly receive power from the power source. The chip may be able to receive power transmitted in accordance with the Qi standard developed by the Wireless Power Consortium or some other wireless power standard. Regardless of its form, the power interface 1818 may allow power to be received from a source external to the durable housing 1802. In addition to the power interface 1818, OMPA 1800 may include a power component 1820 that can store power received at the power interface 1818. The power component 1818 could advantageously be useful to maintain some or all operations (e.g., the state of communications and functionality of electronic components) in the event of a power outage. Examples of power components include rechargeable lithium-ion (Li-Ion) batteries, rechargeable nickel-metal hydride (NiMH) batteries, rechargeable nickel-cadmium (NiCad) batteries, and the like.

In order to produce an OMPA output from OMPA input, OMPA 1800 (and, more specifically, its controller 1810) may control one or more drying mechanisms 1822A-N, one or more grinding mechanisms 1824A-N, and one or more heating mechanisms 1825A-N. The drying mechanisms 1822A-N can be responsible for desiccating the OMPA input. Desiccation may not only allow the OMPA input easier to process (e.g., grind), but also may prevent the formation of mold that thrives in humid conditions. Examples of drying mechanisms include fans that reduce moisture by introducing airflow. For example, a lid can include a fan to impart forced air into processing chamber 1806. Another fan may be used to pull untreated air from the processing chamber 1806 for processing by air treatment mechanism 1826. The grinding mechanisms are responsible for cutting, crushing, or otherwise separating the OMPA input into fragments. Examples of grinding mechanisms include paddles, mixers, impellers, and rotating blades (e.g., with two, three, or four prongs). Grinding mechanisms are normally comprised of a durable material, such as die cast aluminum, stainless steel, or another material that offers comparable strength and rigidity. Heating mechanism 1825A-N may impart heat directly to processing chamber 1806 to assist in drying out any OMPA input contained therein. Examples of the heating mechanism can include one or more flexible heating elements that are integrated within processing chamber 1806 or one or more heating elements that are thermally coupled to processing chamber 1806. As another example, a heater may exist in the lid and can heat the air being forced into processing chamber 1806 by one of drying mechanisms 1822. By working in concert, the drying, grinding, and heating mechanisms 1822A-N, 1824A-N, and 1825A-N can convert OMPA input into a substantially shelf stable product.

Moreover, air may be drawn from the ambient environment into the durable housing 1802 and then expelled into the processing chamber 1806 to help desiccate the OMPA input contained therein. As shown in FIG. 18, air that is drawn from the processing chamber may be treated using one or more air treatment mechanisms 1826A-N (also referred to as “air management mechanisms” or “air discharge mechanisms”) before being released back into the ambient environment. Air treatment mechanisms 1826A-N may convert untreated air emanating from processing chamber 1806 to treated air, which is released from OMPA 1800. Air treatment mechanisms 1826A-N can include a media filter (e.g., activated carbon filter), a photovoltaic filter (e.g., a UV light filter), or a combination thereof.

Other components may also be included in OMPA 1800. For example, sensor(s) 1828 may be arranged in various locations throughout OMPA 1800 (e.g., along the path that the air travels through OMPA 1800). Sensor(s) 1828 can include temperature sensors, humidity sensors, volatile organic compound sensors, and mass sensors. The sensor(s) 1828 may include a proximity sensor that is able to detect the presence of nearby individuals without any physical contact. The proximity sensor may include, for example, an emitter that is able to emit infrared (IR) light and a detector that is able to detect reflected IR light that is returned toward the proximity sensor. These types of proximity sensors are sometimes called laser imaging, detection, and ranging (LiDAR) scanners. Alternatively, the presence of an individual may be inferred based (i) whether sounds indicative of the user are detectable (e.g., by a passive microphone or an active sonar system) or (ii) whether an electronic device associated with the user is detectable (e.g., by the communication module 1816). As yet another example, sensor(s) 1828 can include a charge coupling device (CCD) or camera that can monitor contents contained with processing chamber 1806 and can monitor active processing of the contents contained therein (e.g., by observing operation of grinding mechanism(s) 1822). The video or images captured by the CCD or camera can be wirelessly transmitted to a user mobile device for viewing or can be displayed on a screen residing on the OMPA.

OMPA 1800 may adjust its behavior based on whether any individuals are nearby. For instance, OMPA 1800 may change its operating state (or simply “state”) responsive to a determination that an individual is nearby. As an example, OMPA 1800 may stop driving the grinding mechanisms upon determining that someone is located nearby. Thus, OMPA 1800 could intelligently react to changes in the ambient environment. Over time, outputs produced by the proximity sensor (plus other components of OMPA 1800) could be used to better understand the normal schedule of individuals who frequent the physical space in which OMPA is situated.

In some embodiments, OMPA 1800 includes an ambient light sensor whose output can be used to control different components. The ambient light sensor may be representative of a photodetector that is able to sense the amount of ambient light and generate, as output, values that are indicative of the sensed amount of ambient light. In embodiments where the control output mechanism 1814 is a display panel, the values output by the ambient light sensor may be used by the controller 1810 to adjust the brightness of the display panel.

Over time, the OMPA may cycle between various states to process OMPA input. As mentioned above, the OMPA may be able to convert OMPA input into a relatively stable product (e.g., food grounds) by drying and grinding the OMPA input. The control parameters for drying or grinding the OMPA input may be dynamically computed (e.g., by the controller 1810 of FIG. 18) as a function of the outputs produced by sensors tasked with monitoring characteristics of the air traveling through the OMPA, as well as the mass or weight of the OMPA input in the processing chamber. For example, the control parameters could be dynamically computed as a function of (i) humidity of the air traveling through the OMPA, (ii) temperature of the air traveling through the OMPA, and (iii) weight of OMPA input contained in the OMPA.

As mentioned above, the OMPA may be able to intelligently cycle between different states to process OMPA input. Six different states are described in Table I. Those skilled in the art will recognize, however, that embodiments of the OMPA may be able to cycle between any number of these states. For example, some OMPAs may only be able to cycle between two, three, or four of these states, while other OMPAs may be able to cycle between all six states.

The OMPA may rely on a single target criterion or multiple target criteria to determine when to cycle between these states. The target criteria could be programmed into the memory of the OMPA, or the target criteria could be specified by a user (e.g., through an interface generated by a control platform). Examples of target criteria include moisture level, temperature, and weight. Using moisture level as an example, there may be multiple preset moisture levels (e.g., 10, 20, 30, and 40 percent) from which the target criterion could be selected (e.g., based on the nature of the OMPA input). The OMPA may not measure moisture of the OMPA input, but can instead predict or infer the moisture based on, for example, the humidity of air traveling through the OMPA and the weight of OMPA input. The OMPA could also rely on the average times for completion of these states. Assume, for example, that the OMPA receives input indicative of a request to process OMPA input deposited into the processing chamber. In such a situation, the OMPA may determine when to schedule the various states based on (i) how long those states have historically taken to complete and (ii) the weight of the OMPA input, among other factors. For example, the OMPA may attempt to schedule high intensity processing to be completed overnight as the grinding mechanisms may operate at a noise that might disturb nearby individuals.

TABLE I
Descriptions of states for processing OMPA input.

| State Identifier (ID) | State Description |
|---|---|
| High Intensity Processing | Goal: Achieve the target moisture level at |
| (HIP) | a given temperature. |
| | Details: Temperature, airflow, and/or |
| | grinding mechanisms can be set to high |
| | settings. HIP normally takes at least |
| | several hours to complete, so the OMPA |
| | may attempt to schedule overnight. HIP |
| | may be triggered manually (e.g., via an |
| | interaction with an input mechanism, or |
| | via an instruction provided through the |
| | control platform) or automatically (e.g., |
| | based on a determination that the weight |
| | of the OMPA input exceeds a threshold). |
| Sanitize | Goal: Kill at least a predetermined |
| | number (e.g., greater than 99 percent) of |
| | pathogens. |
| | Details: Settings are similar to HIP, |
| | though the temperature is higher. By |
| | default, sanitization may be performed |
| | before, during, or after HIP. Thus, |
| | sanitization may be considered part of |
| | HIP in some instances. |
| Low Intensity Processing | Goal: Advance drying in a non-intrusive |
| (LIP) | manner while individuals are more likely |
| | to be nearby (e.g., during daylight hours). |
| | Details: Temperature, airflow, and/or |
| | grinding mechanisms can be set to low |
| | settings. While LIP may be similar to HIP |
| | in operation, LIP may be more suitable if |
| | individuals may be nearby. For example, |
| | the noise generated by the grinding |
| | mechanisms will typically be more |
| | tolerable at low settings than at high |
| | settings. |
| Burst Grind | Goal: Incorporate wet (e.g., unprocessed) |
| | OMPA input into dry (e.g., processed or |
| | semi-processed) OMPA input to make |
| | drying easier. |
| | Details: Temperature and airflow may be |
| | maintained at the same settings as the |
| | prior state (e.g., HIP or LIP), but the |
| | grinding mechanisms can be set to a |
| | higher state to grind the wet OMPA input |
| | that has been newly added. Burst grind |
| | may be performed when new OMPA |
| | input is added to the processing chamber |
| | while HIP or LIP is being performed. |
| Standby | Goal: Conserve power once the target |
| | criteria have been reached. |
| | Details: Temperatures, airflow, and/or |
| | grinding mechanisms can be off, unless |
| | necessary to meet some other criterion. |
| | For example, airflow and/or grinding |
| | mechanisms may be occasionally |
| | triggered to maintain an odor criterion. |
| Cooldown | Goal: Allow the user to handle the |
| | processing chamber. |
| | Details: Settings are similar to standby, |
| | though airflow may be higher if necessary |
| | to cool the processing chamber or the |
| | product stored therein. |

As mentioned above, the durations of these states can be dynamically determined based on, for example, analysis of outputs generated by sensors housed in the OMPA. However, the durations of these states are predefined—at least initially—in some embodiments. For example, high intensity processing may be programmed to occur for a certain amount of time (e.g., 4, 6, or 8 hours), and burst grind may be programmed to occur for a certain amount of time (e.g., 30 seconds, 5 minutes, 30 minutes) whenever new OMPA input is added. Those skilled in the art will also recognize that the duration of some states could be dynamically determined, while the duration of other states could be predefined. As an example, the OMPA may continue performing high intensity processing until the target criteria are achieved. However, whenever new OMPA input is added, the OMPA may cycle to burst grind for a certain amount of time (e.g., 30 seconds, 5 minutes, 30 minutes) before reverting back to its previous state.

OMPA 1800 can provide OMDS on demand in response to a request from a back end server, as part of a periodic upload to the back end server, or in response to an event the necessitates the uploading of the OMDS to the back end server.

It should be understood that the foregoing discussion of the OMPA is merely illustrative and that many different OMPA configurations can exist, each of which can operate in connection with the software platform discussed herein. For example, the grinding mechanism, the heating mechanism, or the control scheme for converting OMPA input to OMPA output may be different than that described herein. Other examples of OMPAs, control systems thereof, safety systems thereof, and uses thereof can be found, for example, in commonly owned U.S. patent application Ser. Nos. 17/897,428, 17/897,457, 17/897,499, 17/897,505, 17/897,507, 17/897,515, and 17/897,518, all filed Aug. 29, 2022, and wherein disclosures of each of these patent applications are incorporated herein in their entireties.

It should be further understood that OMPAs such as OMPA 1800 need not be the sole source of OMPA output provided to DRHF processing facilities. Any device that is able to desiccate and grind organic matter may serve as a source of OMPA output. These other devices, however, may not be equipped with OMDS generating capability or more the more sophisticated OMPA processing cycle capabilities, but so long as an owner such lesser devices have obtained a membership with a DRHF processing facility, that DRHF processing facility can accept and process OMPA output received therefrom.

In some situations, it may be desirable to remotely interface with an OMPA. For example, a user may want to initiate high intensity processing if she is not at home and does not expect to return home for an extended duration (e.g., several hours). This could be done through a control platform that is communicatively connected to the OMPA. Thus, the user may be able to interact with the OMPA through the control platform. Through the control platform, the user may also be able to view information regarding the OMPA (e.g., its current state, average duration of each state, how much OMPA input has been processed over a given interval of time, current weight of the bucket and its contents) through interfaces that are generated by the control platform. Furthermore, a backend server, which is running third party management software, may desire to send updates to the OMPA (e.g., based on analysis of OMPA output received in a mailer at a DRHF facility).

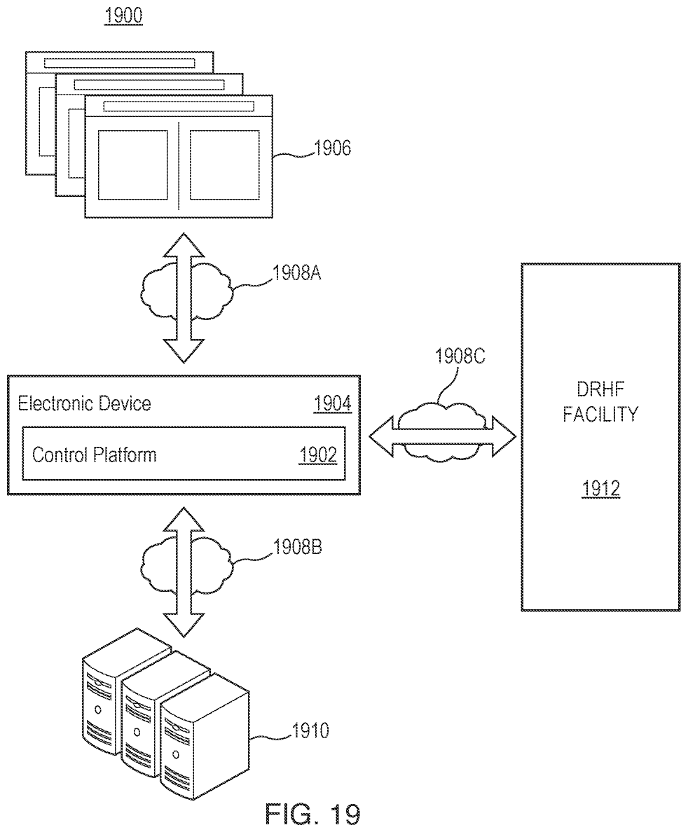

FIG. 19 illustrates a network environment 1900 that includes a data acquisition platform 1902. For the purpose of illustration, platform 1902 may be described as a computer program that is executing on an electronic device 1904 accessible to an operator or a user of DRHF facility 1912. As discussed above, DRHF facility 1912 may include many peripheral devices that can communicate data to and from electronic device 1904 on which platform 1902 resides.

Users may be able to interface with platform 1902 via interfaces 1906. For example, a user may be able to access an interface through which different information obtained from DRHF facility 1912 can be viewed. This information may include customer-tied data, batch-tied data, or operational data related to machinery in DRHF facility 1912.

As shown in FIG. 19, platform 1902 may reside in a network environment 1900. Thus, electronic device 1904 on which platform 1902 is implemented may be connected to one or more networks 1908A-C. Networks 1908A-C may be personal area networks (PANs), local area networks (LANs), wide area networks (WANs), metropolitan area networks (MANs), cellular networks, or the Internet. Additionally or alternatively, electronic device 1904 could be communicatively connected to other electronic devices (e.g., a DRHF control panel) over a short-range wireless connectivity technology, such as Bluetooth, NFC, Wi-Fi Direct (also referred to as “Wi-Fi P2P”), and the like.

In some embodiments, at least some components of platform 1902 are hosted locally. That is, part of platform 1902 may reside on electronic device 1904 that is used to access interfaces 1906 as shown in FIG. 19. For example, platform 1902 may be embodied as a mobile application that is executable by a mobile phone. Note, however, that the mobile application may be communicatively connected to (i) DRHF facility 1912 and/or (ii) a server system 1910 on which other components of platform 1902 are hosted.

In other embodiments, platform 1902 is executed entirely by a cloud computing service operated by, for example, Amazon Web Services®, Google Cloud Platform™, or Microsoft Azure®. In such embodiments, platform 1902 may reside on a server system 1910 that is comprised of one or more computer servers. These computer servers can include different types of data (e.g., historical data of customer accounts, OMDS, and DRHF data), algorithms, etc.

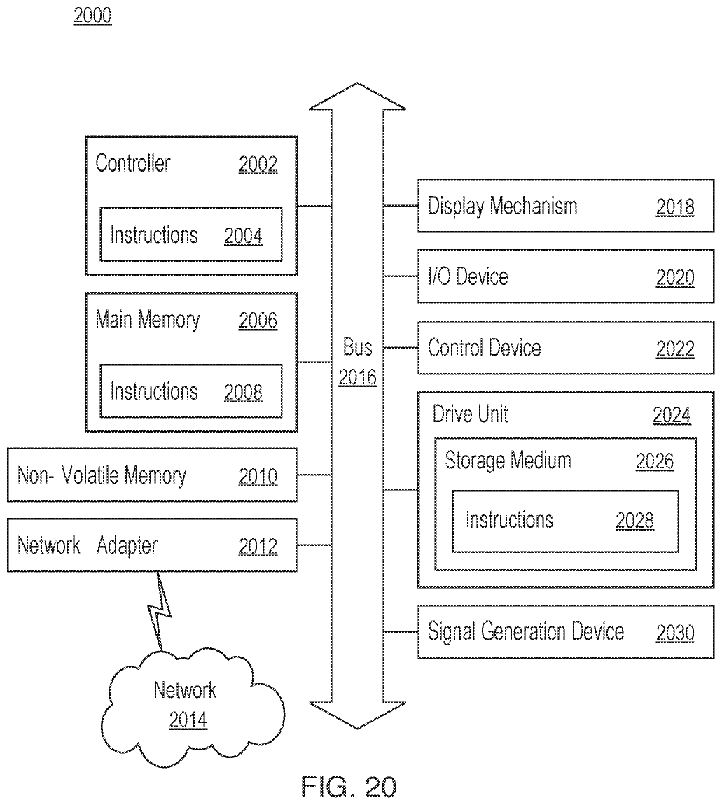

FIG. 20 is a block diagram illustrating an example of a computing system 2000 in which at least some operations and data collection described herein can be implemented. For example, components of the computing system 2000 may be hosted at a DRHF facility. As another example, components of the computing system 2000 may be hosted on an electronic device that is communicatively connected to peripherals associated with a DRHF facility.

The computing system 2000 may include a controller 2002, main memory 2006, non-volatile memory 2010, network adapter 2012, display mechanism 2018, input/output (I/O) device 2020, control device 2022, drive unit 2024 including a storage medium 2026, and signal generation device 2030 that are communicatively connected to a bus 2016. The bus 2016 is illustrated as an abstraction that represents one or more physical buses or point-to-point connections that are connected by appropriate bridges, adapters, or controllers. The bus 2016, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), inter-integrated circuit (I2C) bus, or an Institute of Electrical and Electronics Engineers (IEEE) standard 1394 bus (also referred to as “Firewire”).

While the main memory 2006, non-volatile memory 2010, and storage medium 2026 are shown to be a single medium, the terms “machine-readable medium” and “storage medium” should be taken to include a single medium or multiple media (e.g., a database distributed across more than one computer server) that store instructions 2028. The terms “machine-readable medium” and “storage medium” shall also be taken to include any medium that is capable of storing, encoding, or carrying instructions for execution by the computing system 2000.

In general, the routines executed to implement the embodiments of the present disclosure may be implemented as part of an operating system or a specific computer program. Computer programs typically comprise instructions (e.g., instructions 2004, 2008, 2028) that are set at various times in various memory and storage devices in an electronic device. When read and executed by the controller 2002, the instructions cause the computing system 2000 to perform operations to execute various aspects of the present disclosure.

The network adapter 2012 enables the computing system 2000 to mediate data in a network 2014 with an entity that is external to the computing system 2000 through any communication protocol that is supported by the computing system 2000 and the external entity. The network adapter 2012 can include a network adaptor card, wireless network interface card, router, access point, wireless router, switch, protocol converter, gateway, bridge, hub, digital media receiver, repeater, or any combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

Data produced by embodiments discussed herein may be further processed by artificial intelligence (AI) models that may be capable of making inferences and advanced analytics using the data. The AI models may be trained using historical data sets obtained by the DRHF facility.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

The following provides a listing of various claim sets focusing on DRHF facilities and methods of thereof. The claims, including the incorporated disclosures, cover various embodiments or configurations, methods, algorithms, and structures related to the embodiments defined herein. Features may be mixed between the various claim sets. Thus, various concepts covered in these claims can be integrated into different embodiments. The statement sets below are organized into different concepts. Each statement can be combined with any other statement. References to “any previous statement” expressly extend beyond just the particular subset of statements but refers to any of the statements below.
Statement 1. A system for processing a mailer comprising a tracking number and organic matter processing apparatus (OMPA) output produced by an OMPA, the system comprising:
a dried recovered household food (DRHF) processing facility comprising a primary processing line and an alternative processing line; and
a front end device comprising:
   a user interface for processing user input;
   a communications interface for receiving data from a plurality of peripheral devices; and
   a processor operative to:
      process tracking data obtained by a scan of the tracking number by a first peripheral device;
      identify a customer account based on the tracking data, wherein the customer account is associated with a customer account database comprising OMPA data and DRHF data;
      process user input received via the user interface and data received from the plurality of peripheral devices as part of an evaluation of the OMPA output contained therein;
      populate a data set based on the evaluation, wherein the data set comprises observed characteristics of the OMPA output contained in the mailer; and
      add the data set to the DRHF data associated with the customer account.
Statement 2. The system of any previous statement, wherein the processor is further operative to accept or reject the OMPA output contained in the mailer based on a history of DRHF data associated with the customer account, the data set, the OMPA data associated with the OMPA output, or a combination thereof, wherein in response to an acceptance of the OMPA output, the OMPA output is directed to the primary processing line, and wherein response to a rejection of the OMPA output, the OMPA output is directed to the alternative processing line.
Statement 3. The system of any previous statement, wherein the primary processing line converts the OMPA output to DRHF.
Statement 4. The system of any previous statement, wherein the alternative processing line is one of a compost processing line, a black soldier fly larva processing line, and a secondary processing line that subjects the OMPA output to extra evaluation scrutiny before allowing the OMPA output to be converted to DRHF.
Statement 5. The system of any previous statement, wherein the processor is further operative to direct the OMPA output to the primary processing line when the data set meets predetermined criteria.
Statement 6. The system of any previous statement, wherein the processor is further operative to:
engage in a lite evaluation to populate the data set if the customer account has a history of DRHF data that meets or exceeds predetermined criteria; and
engage in a standard evaluation to populate the data set if the customer account has no prior history of DRHF data or has a history of DRHF data that falls below predetermined criteria.
Statement 7. The system of any previous statement, wherein the processor is further operative to:
compare a subset of the data set to a subset of the OMPA data to determine whether at one discrepancy exists that exceeds a tolerance threshold; and
direct the OMPA output to the primary processing line or the alternative processing line based on the comparison.
Statement 8. The system of any previous statement, wherein the subset of the OMPA data includes a mass value of the OMPA output removed from the OMPA, a moisture value of the OMPA output removed from the OMPA, and timestamp of when OMPA output is removed from the OMPA, and wherein the subset of the data set includes a mass value of the OMPA output removed from the mailer, a moisture value of the OMPA output removed from the mailer, and a timestamp of when the OMPA output is removed from the mailer.
Statement 9. The system of any previous statement, wherein the processor is further operative to:
generate, based on the data set, a report for the customer account; and
transmit the report to a front end device associated with the customer account.
Statement 10. The system of any previous statement, wherein the data set comprises the tracking number, a time stamp, a mass value, a batch number, a photograph, indication of presence of contaminants, and acceptance or rejection of the OMPA input.
Statement 11. A method for processing a mailer comprising a tracking number and organic matter processing apparatus (OMPA) output produced by an OMPA, the method implemented in a front end device that receives user input from an operator and data from a plurality of peripheral devices operating in a processing facility operative to convert OMPA output to dried recovered household food (DRHF), the method comprising:
processing tracking data obtained by a scan of the tracking number by a first peripheral device of the plurality of peripheral devices;
populating a data set tied to an entry of the tracking number based on an inspection of the OMPA output contained in the mailer, wherein the data set is populated with at least one of user inputs and data received from the plurality of peripherals, and wherein the data set comprises the tracking number, mass value obtained from a second peripheral device of the plurality of devices, a batch number, status of whether contaminants are present, and status of whether OMPA output is accepted; and
uploading the data set to a back end server comprising a database for storing data sets tied to each mailer processed by the front end device.
Statement 12. The method of any previous statement, wherein the data set comprises:
a photograph of the OMPA output taken by a third peripheral of the plurality of peripherals; and
a plurality of contamination sources, wherein each contamination source is identified as present or not present, and optionally can include quantitative values.
Statement 13. The method of any previous statement, wherein the plurality of contamination sources are selected from the group consisting of wet/oily, mold, rock and inert object, compostable plastic, paper, metal or foil, and produce label contaminants.
Statement 14. The method of any previous statement, further comprising:
obtaining a customer account based on the processed tracking data;
accessing the customer account to assign a high or low risk factor to the OMPA output contained in the mailer; and
instructing the operator or a machine to route the mailer to a primary processing line or an alternative processing line based on whether the OMPA output has been assigned a high or low risk factor.
Statement 15. The method of any previous statement, wherein the alternative processing line subjects the OMPA input to extra inspection scrutiny than the primary processing line.
Statement 16. The method of any previous statement, wherein when the OMPA output is accepted, routing the OMPA output to a primary processing line that is operative to convert the OMPA output to DRHF, and wherein when the OMPA output is not accepted, routing the OMPA output to one of a compost processing line, a black soldier fly larva processing line, and a secondary processing line that subjects the OMPA output to extra evaluation scrutiny before allowing the OMPA output to be converted to DRHF.
Statement 17. The method of any previous statement, further comprising:
obtaining a customer account based on the processed tracking data;
accessing the customer account to obtain OMPA data from the OMPA that produced the OMPA output contained in the mailer;
comparing a subset of the data set to a subset of the OMPA data to determine whether at one discrepancy exists that exceeds a tolerance threshold; and
direct the OMPA output to a primary processing line or an alternative processing line based on the comparison.
Statement 18. The method of any previous statement, wherein the subset of the OMPA data includes a mass value of the OMPA output removed from the OMPA and timestamp of when OMPA output is removed from the OMPA, and wherein the subset of the data set includes a mass value of the OMPA output removed from the mailer and a timestamp of when the OMPA output is removed from the mailer.
Statement 19. The method of any previous statement, further comprising:
populating a batch data set with data obtained from a plurality of stations existing within the processing facility, wherein the OMPA output contained in the mailer and OMPA output contained a plurality of other mailers have been accepted are associated with a batch number, wherein the batch data set comprises the batch number, equipment operating hours, metal detection events, mass of DRHF contained in a sterilization station, and mass of DRHF contained in a shipping bag; and
uploading the batch data set to the back end server.
Statement 20. The method of any previous statement, further comprising:
inserting a marker into a first OMPA output at an inspection station of the plurality of stations, wherein the first OMPA output passes through a subset of the plurality of stations as the first OMPA output is converted to DRHF, and wherein the marker enhances a statistical probability that the first OMPA output is traceable to a particular mailer;
identifying an issue with the first OMPA output at one of the plurality of stations;
updating the data set associated with the first OMPA output to incorporate the identified issue; and
uploading the updated data set to the back end server.
Statement 21. The method of any previous statement, further processing:
receiving data from the DRHF contained in the sterilization station or in the shipping bag; and
uploading the received data to the back end server for inclusion into the batch data set.
Statement 22. The method of any previous statement, further comprising:
including, in the batch data set, a DRHF utilization partner identified to receive the shipping back containing the DRHF;
determining a plurality of mailers used in the batch;
generating a report for each of a plurality of customer accounts associated with the determine plurality of mailers used in the batch, wherein the report specifies the DRHF utilization partner; and
providing the report to each of the plurality of customer accounts.
Statement 23. A method for producing dried recovered household food (DRHF) in a processing facility, the processing facility comprising an inspection station, a plurality of processing lines each operative to convert OMPA output to DRHF, and an output station, the method implemented in a front end device that receives data from peripheral devices operating in the processing facility, the method comprising:
obtaining tracking number data from tracking labels affixed to a plurality of mailers each comprising OMPA output and a respective tracking label;
obtaining, at the inspection station, data from OMPA output contained in a subset of a first batch of presorted mailers to verify that the first batch comprises OMPA output that meets first processing line criteria, wherein the first batch is converted to a first batch of DRHF by a first processing line of the plurality of processing lines;
obtaining, at the inspection station, data from OMPA output contained in a subset of a second batch of presorted mailers to verify that the second batch comprises OMPA output that meets second processing line criteria, wherein the second batch is converted to a second batch of DRHF by a second processing line of the plurality of processing lines;
obtaining data of the first batch of DRHF and of the second batch of DRHF via respective peripheral devices; and
instructing, based on the obtained data of the first batch of DRHF and of the second batch of DRHF, the first processing line to route the first batch of DRHF to the output station, the second processing line to route the second batch of DRHF to the output station, or the first and second processing lines to selectively mix the first batch of DRHF and the second batch of DRHF to create a DRHF blend that is routed to the output station.
Statement 24. The method of any previous statement, further comprising:
correlating the tracking number data to a customer account comprising customer account data related to the OMPA output contained in the mailer associated with the customer account; and
presorting the plurality of mailers into a plurality of batches each designated for one of the plurality of processing lines, wherein the presorting is based on the customer account data tied to the respective tracking number.
Statement 25. The method of any previous statement, wherein the customer account data comprises OMPA output history of at least one mailer processed at the processing facility.
Statement 26. The method of any previous statement, wherein the customer account data comprises an accounting of OMPA input used to produce the OMPA output received in the mailer containing the OMPA output.
Statement 27. The method of any previous statement, further comprising:
receiving a DRHF order having a first set of requirements; and
wherein the instructing is executed such that first batch of DRHF, the second batch of DRHF, or the DRHF blend is output via the output station to satisfy the first set of requirements of the DRHF order.
Statement 28. The method of any previous statement, wherein the processing facility further comprises a supplement station operative to add feed ingredient supplements to any one of the plurality of processing lines, the method further comprising:
instructing the supplement station to add one or more feed ingredient supplements to the first batch of DRHF, the second batch of DRHF, or the DRHF blend to produce an enhanced DRHF.
Statement 29. The method of any previous statement, wherein the first and second processing lines are substantially similar, wherein a third processing line is a black soldier fly larva collection processing line, and wherein a fourth processing line is a compost line.
Statement 30. A method for producing dried recovered household food (DRHF) in a processing facility, the processing facility comprising an inspection station, a processing line operative to convert OMPA output to DRHF, and an output station, the method implemented in a front end device that receives data from peripheral devices operating in the processing facility, the method comprising:
receiving tracking number data from a plurality of tracking numbers affixed to a corresponding mailer comprising OMPA output, wherein the plurality of tracking numbers are associated with a set of members;
assigning a tag to an outbound package comprising DRHF derived from OMPA output contained in the mailers associated with the set of members, wherein the tag is associated with a data set indicating an end use of the DRHF contained in the outbound package;
providing the tag to a front end device of each of the set of members.
Statement 31. A method for producing dried recovered household food (DRHF) in a processing facility, the processing facility comprising an inspection station, a processing line operative to convert OMPA output to DRHF, and an output station, the method implemented in a front end device that receives data from peripheral devices operating in the processing facility, the method comprising:
receiving tracking number data from a tracking number affixed to a corresponding mailer comprising OMPA output, wherein the tracking number is associated with a non-member;
verifying whether the OMPA output contained in the mailer meets or exceeds predetermined criteria;
generating an invitation for the non-member if the OMPA output contained in the mailer meets or exceeds the predetermined criteria; and
transmitting the invitation to the non-member.
Statement 32. A method for producing dried recovered household food (DRHF) in a processing facility, the processing facility comprising an inspection station, a processing line operative to convert OMPA output to DRHF, and an output station, the method implemented in a front end device that receives data from peripheral devices operating in the processing facility, the method comprising:
receiving a DRHF order having a first set of requirements;
selecting a subset of mailers from a plurality of mailers for use in producing the DRHF, wherein each mailer comprises a tracking number label and OMPA output;
after the OMPA output contained in the subset of mailers is converted to DRHF in the processing line, obtaining evaluation data from at least one peripheral device operative to analyze the DRHF;
determining whether the evaluation data meets the first set of requirements; and
instructing the processing line to transport the DRHF to the output station if the evaluation data meets the first set of requirements such that the output station fulfills the DRHF order.
Statement 33. The method of any previous statement, wherein the processing facility further comprises a supplement station operative to add feed ingredient supplements to the processing line, the method further comprising:
if the evaluation data does not meet the first set of requirements, determining a compensation set of ingredients required to adjust composition of the DRHF to meet the first set of requirements;
instructing the supplement station to add one or more feed ingredient supplements according to the compensation set of ingredients to the DRHF contained in the processing line to provide compensated DRHF; and
instructing the processing line to transport the compensated DRHF to the output station such that the output station fulfills the DRHF order.
Statement 34. The method of any previous statement, further comprising:
obtaining tracking number data from a tracking number label; and
accessing customer account data associated with the tracking number data, wherein the customer account data serves as a basis for selecting the subset of mailers.
Statement 35. The method of any previous statement, further comprising:
obtaining inspection data from OMPA output contained in one of the plurality of mailers; and
adding the OMPA output to the processing line if the inspection data meets predetermined criteria.
Statement 36. A dried recovered household food (DRHF) processing facility, comprising:
an inspection station operative to handle a plurality of mailers comprising OMPA output and a customer-tied tracking number, wherein the inspection station controls a batch of OMPA output derived from a subset of the plurality of mailers for further processing in the DRHF facility;
a processing line operative to convert the batch of OMPA output to DRHF;
an output station to output the DRHF; and
a front end device that receives data from peripheral devices operating in the processing facility, the front end device comprising:
   a processor operative to:
      process the received data to populate a customer-tied data entry based on data obtained from evaluation of the OMPA output contained in one of the plurality of mailers; and
      process the received data to populate a batch-tied data entry based on data obtained from the processing line.
Statement 37. The DRHF processing facility of any previous statement, wherein the inspection station comprises a tracking number scanning peripheral and a mass measuring peripheral, wherein the customer-tied data entry comprises a tracking number and a mass of the OMPA output contained in one of the plurality of mailers.
Statement 38. The DRHF processing facility of any previous statement, wherein the customer-tied data entry comprises a status indication of whether the OMPA output is accepted or rejected for application through the processing line.
Statement 39. The DRHF processing facility of any previous statement, wherein the inspection station comprises an image capturing peripheral, wherein the customer-tied data entry further comprises an image of the OMPA output contained in one of the plurality of mailers.
Statement 40. The DRHF processing facility of any previous statement, wherein the batch-tied data entry comprises a status indication of whether the OMPA output is accepted or rejected for application through the processing line.
Statement 41. The DRHF processing facility of any previous statement, wherein the processing line comprises a metal detection station operative to detect presence of metal in OMPA output, wherein a metal detection event is provided as data to the processor for entry into at least one of the customer-tied data entry and batch-tied data entry.
Statement 42. The DRHF processing facility of any previous statement, wherein the processing line comprises a screening station operative to screen OMPA output according to at least one size range, wherein OMPA output having sizes falling within a first size range are transported to a sterilization station.
Statement 43. The DRHF processing facility of any previous statement, wherein OMPA output having sizes falling below the first size range are transported to an alternative processing line dedicated to converting relatively undersized OMPA particles into DRHF.
Statement 44. The DRHF processing facility of any previous statement, wherein OMPA output having sizes falling above the first size range are transported to an alternative processing line dedicated to handling oversized OMPA particles.
Statement 45. The DRHF processing facility of any previous statement, wherein the processing line comprises a sterilization station operative to sterilize OMPA output and complete conversion of the batch of OMPA output to DRHF, wherein the sterilization station comprises a mass measuring peripheral that provides DRHF mass data to the front end device, wherein the processor includes the DRHF mass data in the batch-tied entry.
Statement 46. The DRHF processing facility of any previous statement, wherein the sterilization station comprises an analytics peripheral that provides DRHF data to the front end device, and wherein the processor includes the DRHF data in the batch-tied entry.
Statement 47. The DRHF processing facility of any previous statement, wherein the output station comprises a mass measuring peripheral that provides DRHF mass data to the front end device, wherein the processor includes the DRHF mass data in the batch-tied entry.
Statement 48. The DRHF processing facility of any previous statement, wherein the output station comprises an analytics peripheral that provides DRHF data to the front end device, and wherein the processor includes the DRHF data in the batch-tied entry.
Statement 49. The DRHF processing facility of any previous statement, wherein the processing line comprises at least one of:
a milling station for reducing a size of the OMPA output or DRHF to a maximum size; and
a mixing station to mix different batches of DRHF or to mix supplemental feed ingredients in with the batch of DRHF.
Statement 50. The DRHF processing facility of any previous statement, wherein the batch-tied entry comprises DRHF mass and a batch number.
Statement 51. The DRHF processing facility of any previous statement, wherein the batch-tied entry further comprises DRHF data, processing line operation hours, metal detection events, DRHF mass at a sterilization station, and DRHF mass at the output station.
Statement 52. A method comprising:
receiving, at a processing facility, a mailer comprising a tracking number and organic matter processing apparatus (OMPA) output produced by an OMPA;
evaluating, at the processing facility, the mailer and the OMPA output contained therein, wherein the evaluating comprises populating a data set that is associated with the tracking number, wherein the data set comprises observed characteristics of the OMPA output contained in the mailer;
generating, based on the data set, OMPA operation instructions specifically dedicated to the OMPA that produced the OMPA output contained within the mailer; and
transmitting the OMPA operation instructions specifically dedicated to the OMPA that produced the OMPA output contained within the mailer such that the OMPA adjusts at least one operation parameter to alter production of a future OMPA output.
Statement 53. The method of any previous statement, wherein the observed characteristics comprise a humidity value of the OMPA output that exceeds a predetermined humidity value, and wherein the OMPA operation instructions comprise an updated setpoint temperature for a heater that operates during a processing cycle of the OMPA.
Statement 54. The method of any previous statement, wherein the OMPA operation instructions comprise an updated runtime for the heater during the processing cycle of the OMPA.
Statement 55. The method of any previous statement, further comprising:
correlating the tracking number with a customer account;
identifying the OMPA that provided the OMPA output in the mailer by accessing the customer account; and
transmitting the OMPA operation instructions to the identified OMPA.
Statement 56. The method of any previous statement, wherein the data set further comprises observed characteristics of the mailer, the method further comprising transmitting a notice to a customer associated with the tracking number.
Statement 57. A system for processing a mailer comprising a tracking number and organic matter processing apparatus (OMPA) output produced by an OMPA, the system comprising:
a front end device comprising:
   a user interface for processing user input;
   a communications interface for receiving data from a plurality of peripheral devices; and
   a processor operative to:
      process user input received via the user interface and data received from the plurality of peripheral devices as part of an evaluation of the mailer and the OMPA output contained therein;
      populate a data set based on the evaluation, wherein the data set comprises observed characteristics of the OMPA output contained in the mailer;
      generate, based on the data set, OMPA operation instructions specifically dedicated to the OMPA that produced the OMPA output contained within the mailer; and
      transmit the OMPA operation instructions specifically dedicated to the OMPA that produced the OMPA output contained within the mailer such that the OMPA adjusts at least one operation parameter to alter production of a future OMPA output.
Statement 58. The system of any previous statement, wherein the observed characteristics comprise a humidity value of the OMPA output that exceeds a predetermined humidity value, and wherein the OMPA operation instructions comprise an updated setpoint temperature for a heater that operates during a processing cycle of the OMPA.
Statement 59. The system of any previous statement, wherein the OMPA operation instructions comprise an updated runtime for the heater during the processing cycle of the OMPA.
Statement 60. The system of any previous statement, wherein the processor is operative to:
correlate the tracking number with a customer account;
identify the OMPA that provided the OMPA output in the mailer by accessing the customer account; and
transmit the OMPA operation instructions to the identified OMPA.
Statement 61. The method of any previous statement, wherein the processor is further operative to transmit a notice to a customer associated with the tracking number based on the data set.

What is claimed is:

1. A system for processing a mailer comprising a tracking number and organic matter processing apparatus (OMPA) output produced by an OMPA, the system comprising:
a dried recovered household food (DRHF) processing facility comprising a primary processing line and an alternative processing line; and
a front end device comprising:
a user interface for processing user input;
a communications interface for receiving data from a plurality of peripheral devices; and
a processor operative to:
process tracking data obtained by a scan of the tracking number by a first peripheral device;
identify a customer account based on the tracking data, wherein the customer account is associated with a customer account database comprising OMPA data and DRHF data;
process user input received via the user interface and data received from the plurality of peripheral devices as part of an evaluation of the OMPA output contained therein;
populate a data set based on the evaluation, wherein the data set comprises observed characteristics of the OMPA output contained in the mailer; and
add the data set to the DRHF data associated with the customer account.

2. The system of claim 1, wherein the processor is further operative to accept or reject the OMPA output contained in the mailer based on a history of DRHF data associated with the customer account, the data set, the OMPA data associated with the OMPA output, or a combination thereof, wherein in response to an acceptance of the OMPA output, the OMPA output is directed to the primary processing line, and wherein response to a rejection of the OMPA output, the OMPA output is directed to the alternative processing line.

3. The system of claim 2, wherein the primary processing line converts the OMPA output to DRHF.

4. The system of claim 3, wherein the alternative processing line is one of a compost processing line, a black soldier fly larva processing line, and a secondary processing line that subjects the OMPA output to extra evaluation scrutiny before allowing the OMPA output to be converted to DRHF.

5. The system of claim 1, wherein the processor is further operative to direct the OMPA output to the primary processing line when the data set meets predetermined criteria.

6. The system of claim 1, wherein the processor is further operative to:
engage in a lite evaluation to populate the data set if the customer account has a history of DRHF data that meets or exceeds predetermined criteria; and
engage in a standard evaluation to populate the data set if the customer account has no prior history of DRHF data or has a history of DRHF data that falls below predetermined criteria.

7. The system of claim 1, wherein the processor is further operative to:
compare a subset of the data set to a subset of the OMPA data to determine whether at one discrepancy exists that exceeds a tolerance threshold; and
direct the OMPA output to the primary processing line or the alternative processing line based on the comparison.

8. The system of claim 7, wherein the subset of the OMPA data includes a mass value of the OMPA output removed from the OMPA, a moisture value of the OMPA output removed from the OMPA, and timestamp of when OMPA output is removed from the OMPA, and wherein the subset of the data set includes a mass value of the OMPA output removed from the mailer, a moisture value of the OMPA output removed from the mailer, and a timestamp of when the OMPA output is removed from the mailer.

9. The system of claim 1, wherein the processor is further operative to:
generate, based on the data set, a report for the customer account; and
transmit the report to a front end device associated with the customer account.

10. The system of claim 1, wherein the data set comprises the tracking number, a time stamp, a mass value, a batch number, a photograph, indication of presence of contaminants, and acceptance or rejection of the OMPA input.

11. A method for processing a mailer comprising a tracking number and organic matter processing apparatus (OMPA) output produced by an OMPA, the method implemented in a front end device that receives user input from an operator and data from a plurality of peripheral devices operating in a processing facility operative to convert OMPA output to dried recovered household food (DRHF), the method comprising:
processing tracking data obtained by a scan of the tracking number by a first peripheral device of the plurality of peripheral devices;
populating a data set tied to an entry of the tracking number based on an inspection of the OMPA output contained in the mailer, wherein the data set is populated with at least one of user inputs and data received from the plurality of peripherals, and wherein the data set comprises the tracking number, mass value obtained from a second peripheral device of the plurality of devices, a batch number, status of whether contaminants are present, and status of whether OMPA output is accepted; and
uploading the data set to a back end server comprising a database for storing data sets tied to each mailer processed by the front end device.

12. The method of claim 11, wherein the data set comprises:
a photograph of the OMPA output taken by a third peripheral of the plurality of peripherals; and
a plurality of contamination sources, wherein each contamination source is identified as present or not present, and optionally can include quantitative values.

13. The method of claim 12, wherein the plurality of contamination sources are selected from the group consisting of wet/oily, mold, rock and inert object, compostable plastic, paper, metal or foil, and produce label contaminants.

14. The method of claim 11, further comprising:
obtaining a customer account based on the processed tracking data;
accessing the customer account to assign a high or low risk factor to the OMPA output contained in the mailer; and
instructing the operator or a machine to route the mailer to a primary processing line or an alternative processing line based on whether the OMPA output has been assigned a high or low risk factor.

15. The method of claim 14, wherein the alternative processing line subjects the OMPA input to extra inspection scrutiny than the primary processing line.

16. The method of claim 11, wherein when the OMPA output is accepted, routing the OMPA output to a primary processing line that is operative to convert the OMPA output to DRHF, and wherein when the OMPA output is not accepted, routing the OMPA output to one of a compost processing line, a black soldier fly larva processing line, and a secondary processing line that subjects the OMPA output to extra evaluation scrutiny before allowing the OMPA output to be converted to DRHF.

17. The method of claim 11, further comprising:
obtaining a customer account based on the processed tracking data;
accessing the customer account to obtain OMPA data from the OMPA that produced the OMPA output contained in the mailer;
comparing a subset of the data set to a subset of the OMPA data to determine whether at one discrepancy exists that exceeds a tolerance threshold; and
direct the OMPA output to a primary processing line or an alternative processing line based on the comparison.

18. The method of claim 17, wherein the subset of the OMPA data includes a mass value of the OMPA output removed from the OMPA and timestamp of when OMPA output is removed from the OMPA, and wherein the subset of the data set includes a mass value of the OMPA output removed from the mailer and a timestamp of when the OMPA output is removed from the mailer.

19. The method of claim 11, further comprising:
populating a batch data set with data obtained from a plurality of stations existing within the processing facility, wherein the OMPA output contained in the mailer and OMPA output contained a plurality of other mailers have been accepted are associated with a batch number, wherein the batch data set comprises the batch number, equipment operating hours, metal detection events, mass of DRHF contained in a sterilization station, and mass of DRHF contained in a shipping bag; and
uploading the batch data set to the back end server.

20. The method of claim 19, further comprising:
inserting a marker into a first OMPA output at an inspection station of the plurality of stations, wherein the first OMPA output passes through a subset of the plurality of stations as the first OMPA output is converted to DRHF, and wherein the marker enhances a statistical probability that the first OMPA output is traceable to a particular mailer;
identifying an issue with the first OMPA output at one of the plurality of stations;
updating the data set associated with the first OMPA output to incorporate the identified issue; and
uploading the updated data set to the back end server.

21. The method of claim 19, further processing:
receiving data from the DRHF contained in the sterilization station or in the shipping bag; and
uploading the received data to the back end server for inclusion into the batch data set.

22. The method of claim 19, further comprising:
including, in the batch data set, a DRHF utilization partner identified to receive the shipping back containing the DRHF;
determining a plurality of mailers used in the batch;
generating a report for each of a plurality of customer accounts associated with the determine plurality of mailers used in the batch, wherein the report specifics the DRHF utilization partner; and
providing the report to each of the plurality of customer accounts.
